(19) United States
(12) Patent Application Publication
(10) Pub. No.: US 2025/0110011 A1
(43) Pub. Date: Apr. 3, 2025

(54) CLEANROOM CERTIFICATION AND HEPA FILTER SCANNING

(71) Applicant: CertAir LLC, Dover, DE (US)

(72) Inventor: Andrew G. Wert, Lutherville, MD (US)

(21) Appl. No.: 18/900,150

(22) Filed: Sep. 27, 2024

Related U.S. Application Data
(60) Provisional application No. 63/586,013, filed on Sep. 28, 2023.

(51) Int. Cl. G01M 3/26; B25J 11/00; F24F 11/39

(52) U.S. Cl. CPC G01M 3/26; B25J 11/00; F24F 11/39

(57) ABSTRACT

A system for cleanroom certification may include one or more robotic device. A robotic device may include an articulated arm configured to scan one or more probes and/or sensors along a path with respect to a filter and/or other device under test. The robotic device may be outfitted with one or more instruments. In some implementations, a robotic device may have a first probe (e.g., an isokinetic probe) connected by a first tube or hose to convey air samples to a first instrument (e.g., a particle counter or photometer), and a second probe connected by a second tube or hose to convey air samples to a second instrument. The robotic device may scan the probes across the filter face, maintaining a constant distance from the filter face, and the instruments may generate data regarding particulates measured/counted in samples obtained during the scan.

### CROSS-REFERENCE TO RELATED APPLICATION

This application claims the benefit of priority of U.S. Provisional Patent Application No. 63/586,013, filed Sep. 27, 2023, and entitled “CLEANROOM CERTIFICATION AND HEPA FILTER SCANNING,” the content of which is incorporated herein by reference in its entirety.

### FIELD OF THE INVENTION

The present invention pertains to testing cleanrooms per industry standards, focusing on systems and methods for measuring the integrity of a cleanroom environment and its devices under test (DUT), including high efficiency particulate air (HEPA), or ultra-low particulate air (ULPA) filters, restricted access barriers, isolation barriers, biosafety cabinets, laminar flow hoods, and/or other contamination control systems.

### BACKGROUND

Cleanroom filter systems play a crucial role in various manufacturing sectors, including healthcare, pharmaceuticals, and semiconductor manufacturing. Regular and meticulous testing of HEPA filters is essential to ensure a cleanroom's compliance with industry standards. Ensuring proper cleanroom operation, industry standards (e.g., under ISO 14644-3, IEST RP CC-34.5) and Good Manufacturing Practices (GMP) mandate regular inspections, which may include integrity tests, airflow tests, and pressure differential tests, among others.

### BRIEF DESCRIPTION OF DRAWINGS

For a more complete understanding of the present disclosure, reference is now made to the following description taken in conjunction with the accompanying drawings.

FIG. 1A illustrates an example multi-axis robotic device in extended position scanning a ceiling-mounted HEPA filter, according to embodiments of the present disclosure.

FIG. 1B illustrates a cart of the robotic device in additional detail, according to embodiments of the present disclosure.

FIG. 2A illustrates an example robot arm with a sensor and plurality of isokinetic probes, according to embodiments of the present disclosure.

FIG. 2B shows another view of the example robot arm and isokinetic probes, according to embodiments of the present disclosure.

FIG. 2C shows a second example robot arm and isokinetic probes, according to embodiments of the present disclosure.

FIG. 2D shows another view of the second example robot arm and isokinetic probes, according to embodiments of the present disclosure.

FIG. 3 illustrates an example of establishing an upstream concentration for multiple instruments, according to embodiments of the present disclosure.

FIG. 4A illustrates an example of rectangular isokinetic probes in coordinated filter scan, according to embodiments of the present disclosure.

FIG. 4B illustrates an example probe path, according to embodiments of the present disclosure.

FIG. 5 illustrates an example automated system data flow, according to embodiments of the present disclosure.

FIG. 6 illustrates an example of mapping a cleanroom environment and performing workflow optimization, according to embodiments of the present disclosure.

FIG. 7 illustrates an example collaborative robot (“cobot”) configuration, validating particle count locations, and workflow optimization, according to embodiments of the present disclosure.

FIG. 8 is a block diagram illustrating data processing operations of the system, according to embodiments of the present disclosure.

FIG. 9 is a block diagram illustrating sensor measurement to airflow visualization operations of the system, according to embodiments of the present disclosure.

FIGS. 10A and 10B illustrate an example visualization of airflow and turbulence, according to embodiments of the present disclosure.

FIG. 11 is a block diagram conceptually illustrating example components of the controller and/or computer device of the system, according to embodiments of the present disclosure.

### DETAILED DESCRIPTION

HEPA filters are used to, among other things, remove particulates from the air in cleanroom facilities. HEPA filters that pass rigorous factory inspections can still leak following installation. The filter, housing, and the associated seals can be damaged during transportation and installation, compromising the integrity of the entire filter system. In-situ testing ensures not only the filter's efficacy but also verifies the robustness of the housing and the tightness of the seals post-installation, guaranteeing a comprehensive quality check.

Evaluating the filter post-installation with in-situ testing provides a comprehensive assessment of the filter, its housing, and seals. However, traditional manual testing methods of in-situ filters (e.g., manual scanning with a handheld probe) can be laborious, time-consuming, and prone to human error. These methods present several challenges:
Inconsistent Scan Rates: Manual movement may lead to variable data quality due to inconsistent speeds and distances from the filter surface.
Limited Data Integration: Difficulty in correlating data from multiple sensors operating asynchronously, leading to potential inaccuracies in detecting leaks or performance issues.
Inefficiencies: Time-consuming processes that result in extended downtime for critical cleanroom operations.

Therefore, an automated system that improves accuracy and efficiency while reducing labor costs is desirable. In particular, the inventor has recognized a need for an automated system capable of:
Concurrent Data Collection: Simultaneously gathering data from multiple sensors to improve accuracy and reduce testing time.
Data Normalization: Handling asynchronous data from various instruments, normalizing it for precise analysis and visualization. This may involve accounting for differences in refresh rates, flow rate fluctuations, baseline measurements, and other factors across multiple photometers and particle counters.
Workflow Optimization: Utilizing advanced software to optimize testing procedures, ensuring compliance with standards like ISO 14644 for Cleanrooms and associated controlled environments, EU GMP Annex 1: Manufacture of Sterile Medicinal Products, NSF/ANSI 49-2022: Biosafety Cabinets Design and Performance, ASHRAE 241 Control of Infectious Aerosols, as examples.

To address these challenges, the present disclosure provides a mobile, transportable automated testing system that may feature:
A mobile base and articulated arm: Capable of reaching various filter orientations while minimizing airflow disruption.
Multiple probes and/or sensors: Including isokinetic probes for measuring aerosol particulate concentrations and environmental sensors, including airflow velocity sensors, pressure sensors, pressure differential sensors, temperature sensors, humidity sensors; contaminant sensors, including CO, CO₂, VOC sensors, E-Nose sensors; and/or other sensors as specified by industry and/or customer testing standards. These probes and sensors may operate concurrently, necessitating robust data normalization capabilities to account for differing flow rates and baseline variances during simultaneous measurements.
Advanced software engine: Executes sensor integration, data normalization, computational fluid dynamics (CFD) analysis, and/or workflow optimization; handling data from instruments with different interface control documents (ICDs).

The systems and methods described herein may offer:
Enhanced efficiency: Reduces testing time by performing simultaneous measurements and optimizing robotic movement.
Improved data accuracy: Normalizes asynchronous data from multiple sensors with varying flow rates and baseline measurements, ensuring consistent and reliable measurements by accounting for differences in sensor placement, sampling rates, and environmental factors affecting aerosol mixing within the ductwork.
Advanced airflow visualization: Enables smokeless visualization of airflow patterns, including laminar flow, turbulence intensity, and detection of currents and eddies, using CFD based on sensor data.
Compliance and flexibility: Ensures adherence to industry standards and adapts to evolving testing protocols.

This disclosure describes a robotic device for automated or semiautomated testing in a cleanroom environment. In some implementations, the robotic device may be an Autonomous Mobile Robot (AMRs) or semi-autonomous mobile collaborative robot, designed for executing tasks, manipulating objects, and traversing within an indoor environment. In some implementations, the robotic device may move about a cleanroom environment on wheels, tracks, legs, etc. In some implementations, the robotic device may be a UAV (Unmanned Aerial Vehicle), which may fly and/or hover as it collects samples, obtains measurements, and/or otherwise inspects the cleanroom environment. In some implementations, the robotic device may be a human robot; for example with articulated arms having joints analogous to a shoulder, elbow, and/or wrist, as well as legs for locomotion.

Offered herein are system and methods for evaluating HEPA filters, performing air quality spot checks, and/or evaluating devices under test (“DUT”). DUTs may include, for example, laminar flow hoods, fume hoods, air showers, pass throughs, environmental chambers, etc. The evaluations may be performed as part of a cleanroom certification program or similar certification of a Device Under Test.

In some implementations, the system may be configured to measure the penetration rate of a cleanroom filter system to evaluate compliance with industry standards. In some implementations, the system may utilize a plurality of isokinetic probes. The probes may be attached to a particle counter or photometer, which may communicate the temporal scanning data to a software application on a laptop, tablet, or phone. In some implementations, the system may include one or more sensors for measuring other characteristics of the cleanroom environment and/or DUTs. This may include sensors for measuring airflow velocity, pressure sensors, pressure differentials, temperature, humidity sensors, CO, CO₂, VOC sensors, E-Nose sensors, and other sensors as required by the test standards. The probe and/or sensor data may be consolidated into a unified test result, verifying a comprehensive and accurate evaluation of the cleanroom's HEPA filters. In some implementations, the system may include a robotic device configured to position and/or scan the probes and/or sensors in an automated or semi-automated fashion. In some implementations, the system may include two or more probes. In some implementations, the system may include one or more sensors in proximity to the probe(s) to facilitate simultaneous measuring of, for example, airflow velocity and particulates. The systems and method described herein may provide several benefits including decreased testing time, lower capital expense, and/or lowering labor costs by automating some or all of the evaluation process.

In some implementations, the robotic device may be mobile and self-positioning relative to its environment, filter, or DUT. For example, the robotic device may include sensors that may be used to determine a position of the robotic device and/or the probe(s) within a room. The sensor(s) may include one or more of a light detection and ranging (LIDAR) sensor, acoustic detection and ranging (e.g., sonar) sensor, thermal sensor, thermal camera, global positioning system (GPS) and/or similar positioning antenna, and/or a Wi-Fi, Bluetooth, or cellular antenna, etc. The sensors may allow the system to capture positional data (e.g., in a Cartesian coordinate system). In some implementations, the system may use data from the sensors to perform point cloud imaging; for example, to recognize objects based on the sensor data. In some implementations, the system may use the positional data and/or sensor data to move the robotic device into position for various tests including, for example, performing air quality spot checks according to a grid of loci in a room. The system's ability to determine its location and/or self-position may improve the precision and reproducibility of evaluation (e.g., over successive periodic evaluations) and aid in validating cleanroom compliance with industry standards such as ISO 14644-3.

Thus, in an example implementation, the system may generate a Cartesian coordinate for at test sample and thus identify each sample location. The system may then repeat the test in the same location while using the same test equipment and parameters. The system may use the location information to generate a map of the evaluated space (e.g., room), detect objects, and identify their locations. In some implementations, the system may include a mobile unit that uses the location information to navigate the space (e.g., autonomously or semi-autonomously), avoid collisions, and obtain samples from the identified location(s). In addition, the system may use the location information to maintain appropriate distances between test locations as well as between test locations and DUTs, which may aid in maintaining compliance with industry standards.

In some implementations, the system may include a mobile robotic device. The robotic device may be an autonomous or semi-autonomous mobile unit. The robotic device may include more than one probe and/or instrument (e.g., a photometer and/or particle counter) for testing the samples. In some implementations, the robotic device may include wheels, tracks, and/or motors for moving through a space. In some implementations, the robotic device may include sensors for navigating the space, positioning the sensor(s), and/or determining a location of the sensor(s) and/or itself relative to the environment and DUT. In various implementations, the self-locating and self-positioning features of the system may provide the following benefits:
Filter and Clean Air Device Identification: The system's capability to automatically identify specific filters, clean air devices, and points of ingress/egress is paramount. By accessing stored performance specifications, the robotic device can tailor its testing approach.
Precise Test Locations: The system may generate Cartesian coordinates for taking test samples, uniquely identifying each location, ensuring consistency and replicability in testing.
Localization of Leaks and/or Repairs: The system may measure location and size of detected leaks and record them as Cartesian coordinates, allowing the system to return the probes and/or sensors to the location of the leak for follow-up measurements. Similarly, the system may measure (or receive as an input) location and size of a leak repair, allowing the system to validate the repair.
Autonomous Testing: The robotic device can automatically detect boundaries of clean air devices and filters while maintaining the required distance between the test location and the clean air device, ensuring compliance with industry standards.
Real-time Navigation and Obstacle Detection: The robotic device may safely navigate the cleanroom environment using real-time maps, localization, object detection, and collision avoidance systems.
Time-stamped Test Data: Storing time-stamped test data and coordinates of the robotic device, test equipment, and clean air device may ensure reproducibility and traceability, which may be helpful for ongoing certification, re-testing, and quality assurance.
Compliance Assurance: By maintaining the required distance between the test location and the clean air device and adhering to strict testing parameters, the robotic device may reduce opportunity for human error and/or ensure compliance with industry standards. The system may be capable of generating certification labels and/or comprehensive certification reports.

In some implementations, the system may include a robotic device. The robotic device may include various probes, sensors, and/or instruments for measuring particulates and/or other contaminants in air as well environmental factors such as temperature, pressure, and/or humidity. A robotic device may have one or more shelves, bays, racks, brackets, etc., configured to receive test equipment such as a plurality of particle counters, photometers, or the like. The use of both photometers and particle counters in various industries further emphasizes the limitation of integrated systems in which the instrument(s) is/are a part of, built into, and/or otherwise permanently or semi-permanently combined with the other parts of the testing system, which may include a controller, chassis, probes, etc. In contrast, the systems described herein may include either integrated or separable standalone devices configured to accept various test equipment. Allowing users to outfit the system with their own test equipment provides flexibility with varied testing requirements across industries and geographical regions while enabling them to leverage capital investments already made in test equipment.

In some implementations, the system may include multiple probes. Each probe may be coupled to a respective particle counter or photometer. In some cases, scanning rates (e.g., the speed with which a probe may be moved across a test region such as a HEPA filter) are specified by industry standards; for example, some industry standards set forth a scanning rate of 5 cm/s. Adding a second probe raises new challenges, however. For example, managing data from multiple probes is non-trivial. For example, to address certification standards such as those specified by ISO 14644-3 and others, the systems described herein may include specialized air sampling equipment and/or software to reconcile possible discrepancies, ensure accuracy, and automate the process when scanning with a plurality of probes.

In some implementations, the robotic device may include one or more sensors and/or instruments configured to measure other characteristics of the clean room environment and/or DUT(s). The sensors/instruments may measure airflow velocity, pressure, pressure differentials, temperature, humidity, CO, CO₂, VOC sensors, E-Nose sensors, and other sensors as required by the test standards.

Another challenge in managing multiple probes is the scanning speed and turn radius of the probe head may be different, depending on the position of the scanning probe relative to the filter face.

In some implementations, the robotic device may include a multi-axis arm configured to position and scan multiple probes and/or sensors for the purpose of conducting integrity tests on High Efficiency Particulate Air (HEPA) or Ultra Low Particulate Air (ULPA) filters; for example, as part of a comprehensive cleanroom certification. In some implementations, components of the robotic device may include:
Multiple isokinetic probes.
Standalone photometers or particle counters.
One or more sensors for measuring airflow velocity, pressure sensors, pressure differentials, temperature, humidity sensors, CO, CO₂, VOC sensors, E-Nose sensors, and other sensors as required by the test standards.
A multi-joint robot arm for positioning and/or rotating the probes and/or sensor(s).
One or more sensors coupled to the robotic device including on the arm.
A base with navigation capabilities.
A controller and/or software for controlling some or all of the robotic device's functions, which may include navigation, positioning, scanning/sampling, etc.
A separable user device (e.g., a laptop, computer tablet, and/or mobile phone) with human-machine interface (HMI) for monitoring, controlling, and displaying real-time data from the robotic device and connected sensors.

The articulated arm may be capable of rotating to optimize its use of multiple sensors for various test configurations. The articulated may rotate to position isokinetic probes and airflow sensors for testing filters that exhaust downward, such as in-situ terminal filters, fixed fan filter units, or biosafety cabinet downflows, or upward, such as biosafety cabinet (BSC) exhaust filters or tabletop-mounted test rig filters, or at an angle, such as an alternate test rig configuration. In some implementations, the arm may include a fixture, to which the probe(s)/sensor(s) mount, that can rotate in multiple axes; for example, the fixture may rotate the probe(s)/sensor(s) perpendicular to the floor to scan vertically mounted filters on walls or measure inward airflow velocity for biosafety cabinets, or at an angle. This flexibility may allow the system to meet diverse filter testing requirements while ensuring compliance with industry standards.

In some implementations, the articulated arm may host other sensors including, but not limited to:
Carbon monoxide (CO) and/or carbon dioxide (CO₂) sensors.
A volatile organic compound (VOC) sensor configured to detect potentially harmful off-gassing of volatile organic compounds.
An E-Nose sensor configured to distinguish complex volatiles in a manner analogous to an olfactory sense.
Other sensors, as required by the test requirements.

Measurements taken with one or more of these sensors may detect the presence of mold, viruses, and/or other environmental contaminants. When combined with data from particulate measurements and/or the environmental sensors previously described, the system may perform computational fluid dynamics (CFD) analysis and/or visualization to aid a user in identifying and pinpointing an ingress of the harmful substance(s). Using the combination of data-such as high humidity, particle spikes in the 2-10 μm range (indicative of mold spores), and the detection of specific volatile organic compounds (VOCs) by the VOC sensor or E-Nose sensor (e.g., mold-released compounds like 1-octen-3-ol)-captured in the precise location, the system can provide insights into detecting microorganisms. These VOCs are metabolic byproducts that signal the presence of contaminants like mold or bacteria. Only with this integrated approach and precise location are we able to potentially classify the pathogen and accurately pinpoint contamination sources. CFD analysis can then identify areas for remediation by simulating airflow patterns, eddying, and entrainment, helping to trace the movement of airborne contaminants and improve environmental control.

In an example operation, the robotic device may perform an aerosol challenge test to identify leaks in the filter media and/or around its frame. The procedure may involve:
Subjecting the filter system to a test aerosol with predefined characteristics (e.g., by introducing the aerosol upstream from the filter system).
Collecting measurements both upstream (dirty side) and downstream (clean side) of the filter system.
Utilizing the robotic device to scan the downstream side.
Determining any leaks by comparing upstream and/or downstream particle concentrations to industry standards.

In some implementations, the robotic device may perform the following probe movement and coordination:
Scanning the probe(s) in a direction parallel to the filter surface.
Adjusting probe movement based on numerous factors such as filter size, filter structure, probe dimensions, position of the scanning probe relative to the filter face, and/or potential obstacles in the probe's path.

In some implementations, the system may perform the following data management and display:
Collecting results from multiple photometers, particle counters, sensors, and/or other instruments.
Measure a location and/or size of a leak and evaluate with respect to industry and/or customer standards.
Record the location/size information of the leak (e.g., as Cartesian coordinates) to allow the robot to return to the site of a leak and measure change over time.
Measure a location and/or size of a leak repair.
Record the location/size information of the leak repair (e.g., as Cartesian coordinates) to allow the robot to return to the site of the repair at a later time and validate the repair.
Consolidating temporal scanning data and providing a singular, unified test result.

In some implementations, the system may offer the following device identification and enhanced features:
DUT identification: The system may employ artificial intelligence (AI) capabilities such as machine learning algorithms to automatically recognize and categorize DUTs within the cleanroom.
Radio-Frequency Identification (RFID) Tagging: Alternatively or additionally, the system may employ RFID tags to uniquely identify a DUT for purposes of storing/retrieving test and/or repair history. Additionally or alternatively, the system may employ quick-response (QR) codes, 2D barcodes, and/or other computer-readable radio and/or optical labeling systems.
Specialized air sampling equipment: To establish a 100% upstream concentration using multiple instruments (e.g., photometers and/or particle counters, etc.), a Y-adapter or Y-valve may be integrated into the upstream ports of both instruments. This may aid in transitioning upstream sampling between two instruments and facilitate accurate relative measurements.
Software integration and data fusion: The software platform may merge temporal scanning data from separate instruments to produce accurate and comprehensive test results. The software may reconcile possible discrepancies and fuse data from multiple sources, offering a consolidated and reliable report.

The system may include a software engine that can enable multiple sensors and/or instruments to function together effectively. The software engine may merge data from various probe/sensor/instrument types, including those from different manufacturers. The software engine may leverage interface control documents (ICDs) for the disparate probes/sensors/instruments to synchronize and normalize their data for combined analysis and/or visualization.

For example, the software engine may facilitate the interchangeability of instruments such as photometers and particle counters. The software engine may be capable of synchronizing, normalizing, and/or aligning data even when multiple photometers or particle counters are deployed and generating simultaneously. This may allow for precise assessments of particle penetration rates and other critical performance metrics, regardless of the specific instruments in use.

Scanning the filter either lengthwise or widthwise may complexity to calculating the percentage of particulate penetration. For instance, one photometer may measure an upstream particulate concentration, while another may measure a downstream concentration. Additionally, some photometers and particle counters from different manufacturers may provide varying data refresh rates, ranging from less than 100 milliseconds to several seconds.

In some cases, test equipment may internally timestamp their temporal data, while other test equipment may provide continuous readings that rely on the computer or human-machine interface (HMI) to assign timestamps upon data receipt. Complicating matters further, samples collected by the isokinetic probes must travel through hoses or tubes spanning up to 6 meters or more before reaching the photometer or particle counter for measurement. This introduces a delay between the actual sampling at the probe and the measurement at the instrument, affecting the correlation between the data and the precise location on the filter during scanning.

The system may perform data normalization to integrate data from multiple instruments and/or sensors. The software engine may receive the data asynchronously, and the data may have varying data rates, units, and formats. A data normalization module of the software engine may perform, for example:
Temporal alignment:
   Timestamp synchronization: The system may align data from sensors with different refresh rates (e.g., an E-Nose sensor may update every second, while a particulate counter may update every 100 milliseconds). The system may interpolate and/or aggregate data to match timestamps, ensuring accurate temporal correlation.
   The system may include software that can synchronize data from various instruments and/or sensors with different refresh rates. For example, one instrument may output a measurement ever second while a sensor may output measurements ten times a second. This synchronization may ensure accurate temporal correlation between, for example, particle counter data, environmental sensor data, odor detection device data, etc.
Spatial alignment:
   Positional mapping: Using data from positioning sensors (e.g., LIDAR, inertial measurement units, GPS, object recognition, etc.), the system may correlate sensor readings to precise spatial locations within the cleanroom environment and/or on a DUT.
   The system may map sensor readings to locations within the cleanroom environment using positional data to enhance the precision and accuracy of source localization.
Data normalization:
   Unit conversion and scaling: The system may convert measurements to consistent units (e.g., converting various gas concentration units to parts per million) and/or normalize sensor outputs to a common scale.
Flow Rate Adjustment and Baseline Calibration:
   Flow rate normalization: The system accounts for varying airflow rates among photometers and particle counters, which have an allowed operating tolerance of −10%+15%, by adjusting measurements in real-time based on each instrument's specific flow rate during the test. This ensures that particulate concentrations are accurately compared across instruments despite differing airflow conditions.
   Baseline calibration: Each photometer or particle counter may have a different baseline for determining leak thresholds due to factors such as the distance between injection and sampling ports, duct construction, and the use of diffusers. The system calibrates each instrument's baseline by referencing standardized calibration parameters, ensuring consistent leak threshold determination across all devices.

The system may perform various analyses by integrating normalized/synchronized data from the E-Nose sensor, CO and CO₂ sensors, aerosol particulate counters, and/or environmental sensors. Such analyses may include:
Multivariate analysis:
   Correlation analysis: The system may identify statistical correlations between elevated VOC levels (e.g., indicative of mold presence), increased fine particulate concentrations (which may carry viruses), and/or environmental conditions such as high humidity or stagnant airflow.
Computational fluid dynamics (CFD) visualization:
   Airflow modeling: The system may use CFD algorithms to simulate airflow patterns within the cleanroom environment based on measured airflow velocity, pressure differentials, and/or other environmental measurements.
   Contaminant dispersion simulation: By incorporating sensor data on particulate concentrations, VOC levels, and/or environmental parameters, the system may build a CFD model that can predict the movement and concentration gradients of contaminants such as mold spores, viral particles, VOCs, etc.
Source Identification:
   Ingress point localization: The system may analyze areas where CFD simulations indicate airflow patterns converge with high contaminant concentrations. This convergence may indicate a potential ingress point and/or sources of mold or other contamination.

The system can integrate and visualize data to provide objective identification of ingress points for mold, viral, and/or other contaminants. For example, the system may perform functions including:
Identifying environmental conditions favorable to contamination, such as areas with elevated humidity and/or temperature readings, combined with poor airflow. Such conditions can promote mold growth and viral persistence.
Detecting VOC emissions and fine particulate matter. An E-Nose sensor may detect VOCs emitted by mold at specific locations, indicating active mold presence. Moreover, increased concentrations of fine particulate matter detected by aerosol particulate counters may indicate areas with higher potential for viral contamination.
Correlating contamination with airflow patterns. The system may generate CFD visualizations that reveal how contaminants may be transported within the cleanroom, helping to trace back to the original sources of mold and viral contaminants.
Isolating sources. By overlaying instrument/sensor data on the CFD model, the system can pinpoint locations where mold-related VOCs and fine particulate matter concentrations are highest and/or where airflow patterns suggest ingress.
Objective source identification. By integrating normalized and synchronized data from all sensors and overlaying this on CFD models, the system aids a user to objectively pinpoint the locations of mold ingress.

The system may integrate and visualize data to perform root cause analysis for purposes of contamination control. For example, the system may facilitate:
Proactive remediation. The system may indicate where targeted cleaning and/or remedial maintenance may be performed to eliminate sources of mold spores, viral particles, VOCs, etc., reducing contamination and health risks. Such remediation may include, for example, targeting identified areas, adjusting HVAC systems, and/or modifying airflow patterns to prevent future contamination.
System improvements. The system may indicate where adjustments to HVAC systems and/or environmental controls (e.g., increasing ventilation rates or optimizing airflow patterns) can potentially prevent future contamination.
Continuous monitoring. The system may record baseline-adjusted measurement data from specific locations to allow for consistent follow-up measurements. Such ongoing data collection can track the effectiveness of remediation efforts.
Using pattern recognition and/or predictive modeling. The system may use data fusion methods, including data normalization and/or synchronization, to accurately merge and interpret data from heterogeneous instrument and/or sensor sources. Over time, the system may use collected data to identify patterns (e.g., “fingerprints”) that correlate with mold outbreaks. The identified patterns can serve as diagnostic tools for predicting and potentially preventing future mold growth, even in absence of direct sampling.

In an example method of operation, the operations may comprise: collecting temporal data from multiple sensors including E-Nose sensors, CO and CO₂ sensors, aerosol particulate counters, airflow velocity sensors, pressure sensors, temperature sensors, and humidity sensors; normalizing and synchronizing the collected data using a data normalization software engine to align temporal and spatial aspects; simulating airflow patterns and contaminant dispersion using a computational fluid dynamics (CFD) module based on normalized sensor data; integrating normalized sensor data with CFD simulation results to visualize contaminant concentrations and airflow paths; objectively identifying mold ingress points by analyzing areas where high contaminant levels coincide with airflow patterns indicative of contaminant sources.

In some embodiments, it may be possible to integrate sensors and locate them closer to the end-of-arm of the robotic device for real-time data acquisition. By placing sensors such as photometers, particle counters, airflow velocity sensors, and pressure sensors directly on or near the end-of-arm tooling, the system can reduce or eliminate delays caused by sample transit through hoses or tubes. This proximity allows for immediate measurement of samples, enhancing the accuracy of correlating data with precise test locations on the filter during scanning.

The data normalization module of the software engine may take into account various different scenarios, including variations in sensor placement, data acquisition methods, and potential delays. Whether sensors are located remotely with sample transit delays or integrated near the end-of-arm for real-time measurements, the software engine may adjust for the delay to ensure accurate synchronization and normalization of data. By doing so, the software engine may ensure that each data point corresponds precisely to the sensor's position on the filter at the exact moment of measurement, which is crucial for generating reliable test results and visualizations.

By consolidating data from multiple sensors, regardless of their physical placement on the robotic device, the software engine may provide a unified test result for a precise location on the filter or DUT. In doing so, the software engine may reconcile variations in probe/sensor location, timestamp assignment, and distance to the DUT, as well as compensating for delays introduced by sample transit when applicable. The software engine may account for the time it takes for samples to travel from an isokinetic probe to the corresponding instrument and/or adjust for immediate readings from instruments located near its corresponding sensor. This can ensure that the measurement data accurately corresponds to the specific location on the filter at the time of sampling.

The software engine may include a computational fluid dynamics (CFD) module and/or visualization model that can generate accurate 2D and 3D visualizations of airflow that represent airflow features such as laminar airflow, currents, turbulence, eddies, etc. To generate these visualizations, the system may determine Cartesian coordinates of sampling locations. The software engine can combine measurements from multiple sensors, taken at different times and positions, and align them to a common reference point on the DUT. This may involve adjusting for sensor-specific delays, transit times and/or timestamp discrepancies.

In some implementations, the system may create a map of the cleanroom environment, including a meshed map of the cleanroom, anteroom, buffer areas, filters, and heating, ventilation, and air conditioning (HVAC) infrastructure. The DUTs may include clean air devices (e.g., biosafety cabinets), workstations, and filters. The system may generate Cartesian coordinates for test sample locations, where the coordinates are based on room size, test requirements, and the location of identified filters and DUTs.

The system may take upstream air samples from HVAC ports to, for example, serve as a baseline reading for the effectiveness of a filter at removing particulates from the air. A sample location may be assigned a unique identifier, enabling accurate and replicable testing. A machine learning algorithm may optimize the workflow within the cleanroom by minimizing the travel distance of the robotic device between test locations and DUTs, enhancing overall efficiency.

The system and its probes and sensors may provide supplementary functions used in cleanroom certification and optimization, including:
Real-Time Mapping
Thermal Scanning
Additional Certification Tests
Workflow Optimization

In some implementations, the system may be configured to operate in a collaborative robot (“cobot”) mode, where the robotic device functions alongside a human operator. In a cobot configuration, the operator can manually move the robotic device, which will annunciate (e.g., via sound, light, or vibration) when the probes and/or sensors are correctly positioned for sampling. This collaboration ensures accuracy and repeatability while allowing for human oversight.

In some implementations, the system may create a map of the cleanroom. Using the map, the software engine may determine a number of, and locations for, particle count test sample acquisition (e.g., based on room size, ISO class, and work surface areas, etc.). Machine learning models may identify testing locations, plan paths, and navigate to designated sampling locations efficiently.

In cobot mode, the robotic device may assist the operator by indicating when the robotic device is in the correct position to obtain a sample from a test location. The system may obtain samples, measure them using instruments, and record data such as particle count and location. The records may be used to, among other things, ensure consistency across subsequent evaluations.

In some implementations, the system may leverage Cartesian coordinates for precision and repeatability, involving:
Mapping the cleanroom or zone within a cleanroom
Planning sampling locations
Locating the robotic device's position within the cleanroom or zone
Mapping a DUT's precise location and position within the cleanroom or zone
Identifying a DUT based on location
Positioning robotic device and/or probe(s)/sensor(s) relative to the DUT

In some embodiments, the system can include integrated data analysis and CFD visualization. The system may include the following sensors and data processing modules:
Aerosol Particle Counters and Photometers: Measure particulate concentrations, by count by discrete size, and by mass.
Environmental Sensors: Measure airflow velocity, pressure, temperature, humidity.
E-Nose Sensors: Detect VOCs associated with mold.
CO and CO₂ Sensors: Measure gas concentrations.
Data Normalization Module: Synchronizes and normalizes data from all sensors.
CFD Module: Performs computational fluid dynamics simulations based on sensor data.
Analysis Module: Integrates normalized sensor data with CFD results to identify contamination sources.

Using the aforementioned sensors and modules, the system may perform one or more of the following operations:
Data collection: The robotic device may navigate (e.g., autonomously, semi-autonomously, and/or in Cobot configuration) the cleanroom, collecting data from multiple sensors simultaneously.
Data Normalization and Synchronization: The data normalization module may align data from multiple sensors and/or instruments temporally and/or spatially.
CFD Simulation: The CFD module may use airflow velocity, pressure data, and/or other environmental measurements to simulate airflow patterns. The CFD module may further incorporate particulate measurements, VOC data, and environmental conditions to model contaminant dispersion.
Source Identification: An analysis module can overlay sensor data on the CFD model. The overlay can identify areas where high contaminant concentrations coincide with airflow patterns, which may indicate potential ingress points for mold and viral contamination.
Visualization and reporting: The analysis module may generate visualizations showing contaminant concentrations and airflow paths. The visualizations can provide actionable insights for contamination control.
Identifying the source of contamination. The system may perform targeted monitoring of identified areas of concern using. The targeted monitoring may include measuring particle size, concentration, airflow velocity, pressure/pressure differentials, moisture levels and/or VOC levels, etc., near suspected problematic zones (e.g., as identified using pattern recognition). Additionally or alternatively, the system may indicate a potential source of contamination to trigger automatic, semi-automatic, and/or manual positioning of probe(s) and/or sensor(s) closer to the potential source to collect additional data for further refinement of source identification (e.g., near specific vents, leaks, equipment, etc.).

In some implementations, the system may include a concurrent data collection mechanism capable of performing simultaneous measurements using multiple sensors and probes integrated into the robotic device. Thus, the articulated arm may be equipped with one or more of:
Multiple isokinetic probes
An airflow velocity sensor
A pressure sensor
A temperature sensor
A humidity Sensor

To account for differences in the measurement and/or data rate of various instruments and/or other test equipment, the software engine may include features for asynchronous data collection and normalization. Due to the varying data refresh rates of the instruments (ranging from 100 ms to 2 seconds) and the potential for sensor placement variations, the system may employ a data normalization module. The data normalization module may synchronize data from:
Test equipment such as a photometers, particle counter, etc.: These may be located remotely with samples traveling through hoses or tubes, or integrated closer to the end of the articulated arm for closer to real-time measurements.
Airflow velocity sensor and pressure sensor: Positioned either on the articulated arm or near the end of the arm tooling, affecting data acquisition timing and synchronization.

The data normalization module of the software engine may be configured to account for various sensor placements, including embodiments where probes/sensors are integrated near the end of the articulated arm, which may affect transit time of the sample between the sample location and the measuring instrument. By accounting for differences in data acquisition methods, sample transit times, and sensor proximities, the software engine can correlate data (e.g., from a single source or multiple different sources) with precise test locations with respect to the DUT or sampling location.

The data normalization module may further provide for receiving simultaneous measurements from different instruments, including instruments having different data rates, formats, units, scales, etc. The data normalization module may synchronize and/or normalize the data from the different instruments to allow the system to make simultaneous measurements using multiple probes and/or sensors, even using mismatched equipment. Merging simultaneous measurements in this manner may yield several benefits including:
Increased efficiency and reduced testing time: The ability to collect multiple data types concurrently may reduce the overall time required for comprehensive testing.
Improved data accuracy and correlation: Simultaneous measurements may ensure that data points from different sensors correspond to the same spatial and temporal references, enhancing the reliability of analyses.
Advanced airflow analysis: Concurrent collection of airflow velocity, pressure, temperature, and/or humidity data may allow for detailed characterization of airflow without the need for smoke, enabling smokeless airflow visualization through CFD.
Flexibility in workforce management: Service technicians can easily utilize different equipment from their available inventory pool, allowing them to adapt to various testing requirements without being restricted by specific tool compatibility, thus optimizing resource use.

The software engine may further include a sensor integration layer. The sensor integration layer may include:
Device drivers: Interfaces with third-party test equipment (photometers, particle counters, airflow sensors, pressure sensors, temperature sensors, humidity sensors) using their specific ICDs.
API management: Handles communication protocols and data formats, allowing seamless addition of new devices.

The software engine may further include the data normalization module previously described. The data normalization module may provide for:
Timestamp Synchronization: Aligns data from devices with refresh rates, ensuring accurate temporal correlation. This includes compensating for equipment that internally timestamps data and those that rely on external systems for timestamping, as well as adjusting for delays caused by sample transit.
Spatial Alignment: Maps data to precise locations on the filter surface, adjusting for the robotic arm's movement, sensor positions, and sample transit delays. The module calculates the time difference between when the sample is collected at the probe and when it is measured by the instrument, ensuring accurate spatial-temporal mapping.
Data Fusion Algorithms: Combines datasets from multiple sensors, resolving discrepancies due to asynchronous sampling, varying data quality, and transit time delays, to produce a cohesive and accurate dataset.

The software engine may further include a CFD module. The CFD module may provide for:
Airflow characterization: The system may use synchronized data from airflow velocity sensors, pressure sensors, temperature sensors, and/or humidity sensors to calculate parameters such as:
   Turbulence intensity: The system may determine turbulence intensity by, for example, calculating the root mean square of velocity fluctuations over the mean velocity to assess flow uniformity.
   Coefficient of variation: The system may calculate the coefficient of variation as, for example, the standard deviation divided by the mean velocity, indicating the consistency of airflow.
   Reynolds number: The system may compute the Reynolds number using, for example, air density (derived from measured temperature and pressure) and mean velocity to indicate turbulence and potential eddies.
Airflow visualization: The system may generate 2D and 3D visualizations of airflow patterns, including laminar flow, turbulence, currents, and eddies, without the need for traditional smoke visualization methods.
CFD Analysis: The system may process the collected data through CFD algorithms to model and/or predict airflow behaviors within the cleanroom environment.

The system may enhance the capability of airflow characterization by leveraging data from multiple sensors to perform smokeless airflow visualization (and/or to augment smoke-test based airflow visualization). By collecting data at precise locations and different distances from the filter face, the system may:
Quantify airflow characteristics: The system may calculate turbulence intensity, coefficient of variation, and Reynolds number to assess flow uniformity and detect potential turbulence and eddies.
Enhance visualization accuracy: With multiple parallel passes of the airfoil-shaped arm, the system may obtain discrete measurements that enable detailed and accurate visualization of airflow patterns.
Supplement or replace smoke studies: The system can provide an alternative to traditional smoke visualization methods by generating high-resolution visualizations through detailed airflow velocity measurements and CFD analysis.

The system may perform various data processing for airflow visualization including one or more of:
Data collection: Simultaneously collect data from multiple sensors during scanning operations.
Data normalization: Adjust for any delays or discrepancies in sensor data to ensure accurate correlation with spatial positions.
CFD processing: Feed the normalized data into CFD algorithms to model airflow behaviors.
Visualization output: Generate visualizations in formats such as 2D/3D graphs, animations, and/or augmented reality overlays to represent airflow patterns.

The data normalization module may address one or more of multiple differences in data formats between different instruments and/or sensors:
Variable refresh rates: Various instruments and/or sensors of the system may operate at different refresh rates (e.g., outputting measurement data with different frequencies), leading to asynchronous data streams that complicate accurate correlation. The system may synchronize these data by aligning timestamps and interpolating or aggregating data points, enabling coherent analysis across all inputs.
Null data sets and inconsistent data outputs: In some cases, an instrument or sensor may produce null data or no data at all (e.g., when a valid measurement may be expected). Moreover, not all test equipment supports the same data output formats as specified in the ICD. As a result, datasets from respective sources may be incomplete or incompatible. The system may resolve a gap or incompatibility by validating data, filling the gap through imputation techniques, and/or converting diverse data formats into a standardized schema, thus maintaining data integrity and ensuring compatibility across the system. Additionally, the system may implement fallback mechanisms to handle missing or corrupt data, ensuring continuous and reliable operation during testing.
Data fusion: Integrating (e.g., merging) heterogeneous data types with varying units and formats may present a challenge for unified analysis. The system may normalize instrument and/or sensor outputs into consistent units and/or scales, facilitating comprehensive analysis and enabling advanced modeling and accurate correlation of, for example, environmental factors with contamination events. Furthermore, the data normalization module may employ advanced algorithms to intelligently fuse data from diverse sources, enhancing the overall reliability and accuracy of leak detection and airflow characterization.

The system may include features for generating visualizations of the cleanroom environment, DUTs, airflow, and/or source of contamination, etc. These features may include:
Converting LiDAR images: Raw LiDAR data may be complex and difficult to interpret directly. The system may process LiDAR data into detailed spatial representations, such as 3D models or maps, allowing users to visualize the cleanroom layout and identify structural factors affecting airflow and contamination.
Digitizing cleanroom maps: Cleanroom configurations may change over time, rendering outdated schematics unreliable for analysis. By digitizing current cleanroom maps using up-to-date sensor data and LiDAR imaging, the system may ensure that accurate spatial models are available, enhancing the reliability of contamination control measures. By digitizing cleanroom maps using up-to-date sensor data and LiDAR imaging, the system ensures that accurate spatial models are available. This allows technicians to confirm that the Device Under Test (DUT) matches its unique DUT ID, thereby ensuring that the test results are associated with the correct location and equipment. Real-time visualization of the cleanroom map also enhances the technician's ability to verify and validate the test processes with precise spatial references.
Output formats: Different stakeholders may require data visualizations in various formats for effective understanding and communication. The system may offer multiple output formats-including 2D and 3D models, heatmaps, and interactive dashboards-enhancing user engagement and supporting informed decision-making.

The system may include a software engine for analyzing the various measurement data to aid airflow optimization. The software engine may perform or facilitate:
Root cause analysis: Identifying the underlying causes of contamination may be a complex undertaking due to multiple environmental factors and potential sources. By analyzing integrated sensor data, the system may pinpoint potential contamination sources, such as leaks or inadequate ventilation, enabling swift remediation and preventing recurrence.
Airflow optimization: Inefficient airflow can lead to stagnant air zones and increased contamination risk. Utilizing computational models, the system may analyze current airflow patterns and recommends adjustments to optimize airflow, improving air circulation, and reducing contamination hotspots.
“What-If” scenarios: Implementing changes without understanding their impact can result in unintended consequences. The system may allow users to simulate hypothetical changes—such as modifications to HVAC settings or cleanroom layouts—and predicts their effects on airflow and contamination levels, supporting proactive planning and enhancing contamination control strategies.

In some embodiments, the system may include instruments integrated directly near the end of the articulated arm—that is, near the probe(s)/sensor(s)—for real-time or near-real-time measurement of samples. By placing photometers, particle counters, airflow velocity sensors, and pressure sensors closer to the point of sample collection, the system may enable one or more of the following:
Eliminate sample transit delays: Reduce or eliminate the time it takes for samples to travel through hoses or tubes to the instruments, enhancing the accuracy of data correlation with specific filter locations.
Enhance real-time processing: Provide immediate measurement data to the processors, allowing for faster data processing and analysis.
Improve measurement precision: Minimize potential sample degradation or contamination that could occur during transit through hoses or tubes.

The data normalization module may be configured to account for end-of-arm instrument implementations by adjusting its algorithms to account for the immediate availability of data corresponding to end-of-arm probe(s)/sensor(s). This can ensure that regardless of sensor placement, the system can maintain accurate synchronization, normalization, and correlation of data for reliable testing and analysis and/or accurate visualization.

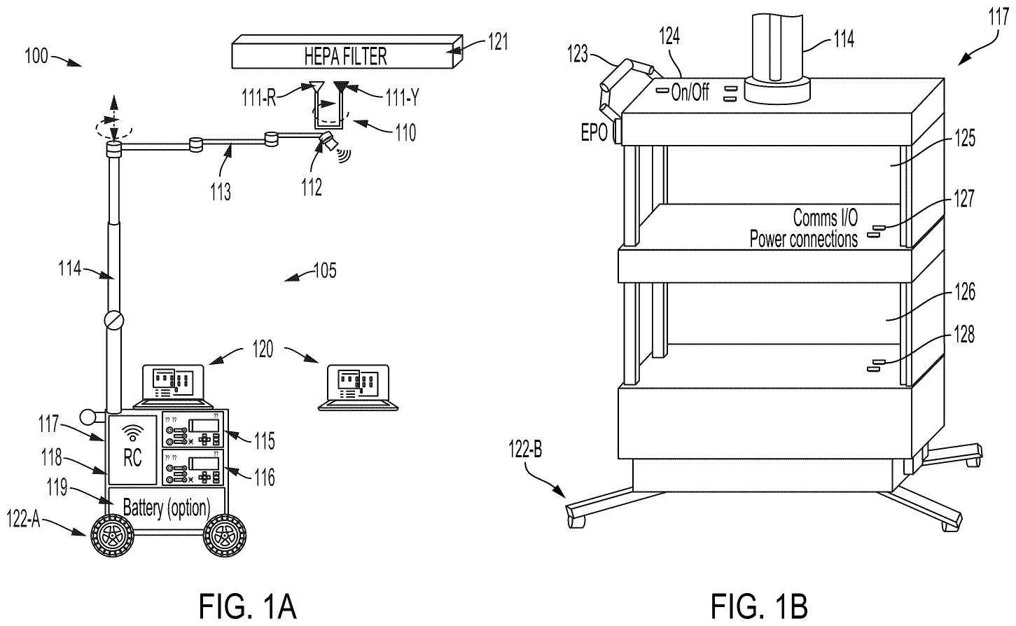

FIGS. 1A through 7 illustrate various aspects of a mobile in-situ test system including the robotic device and its operation

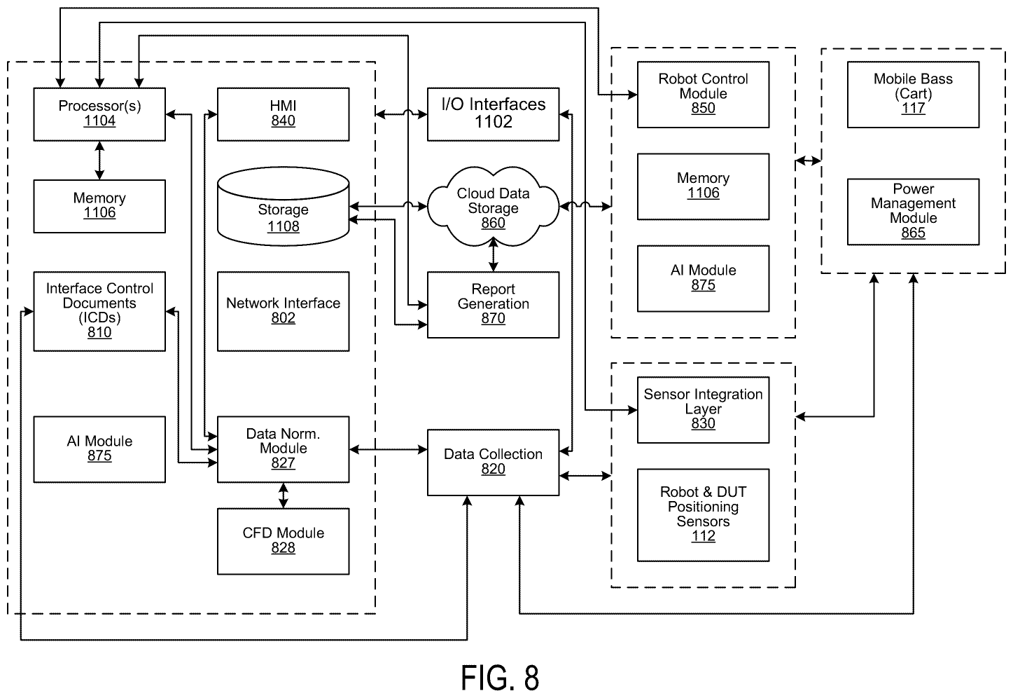

In some implementations, certain aspects of the test system may be embodied in a stationary device configured to, for example, test filters prior to installation. In some implementations, the stationary system may store results of initial and/or post-repair testing. An RFID tag applied to, or otherwise associated with, the DUT may be used to retrieve the test results and/or store new test results for the DUT. FIG. 8 illustrates various aspects of a stationary test system and its operation.

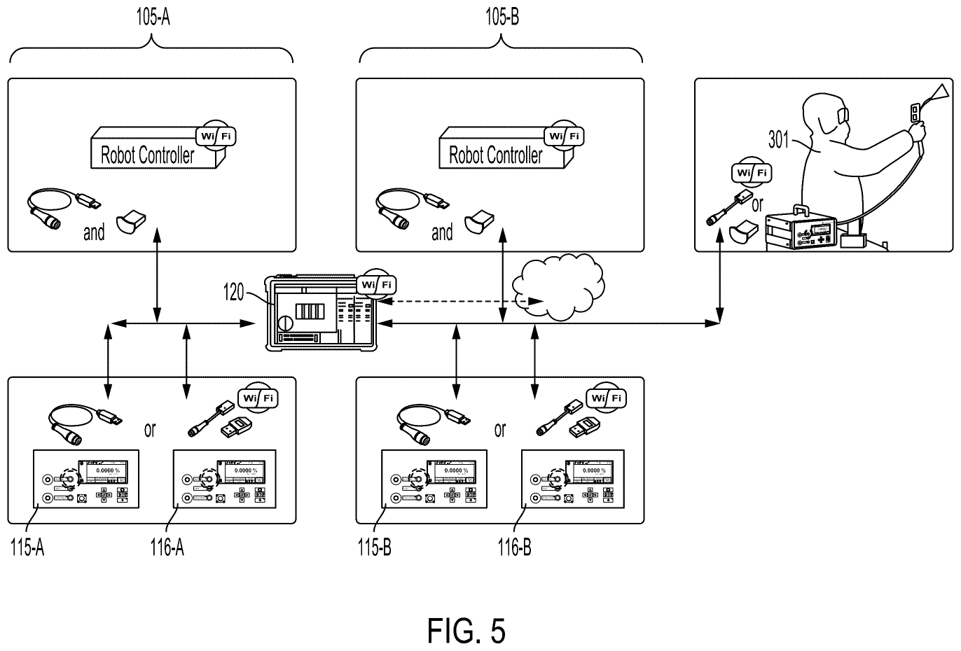

FIG. 1A illustrates an example of a multi-axis arm of a robotic device 105 in extended position scanning a ceiling-mounted HEPA filter. The robotic device 105 may be part of a measurement system 100. In some implementations, the system 100 may include multiple robotic devices 105-A and 105-B (e.g., as described below with reference to FIG. 5). As shown in FIG. 1A, the robotic device 105 may include various components including probes, sensor, and the robotic device arm.

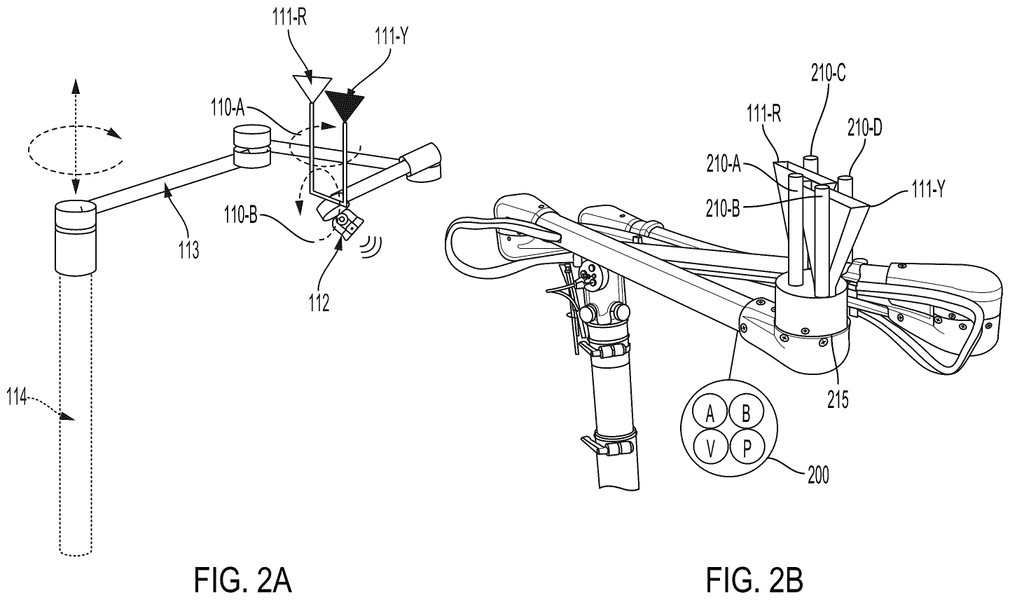

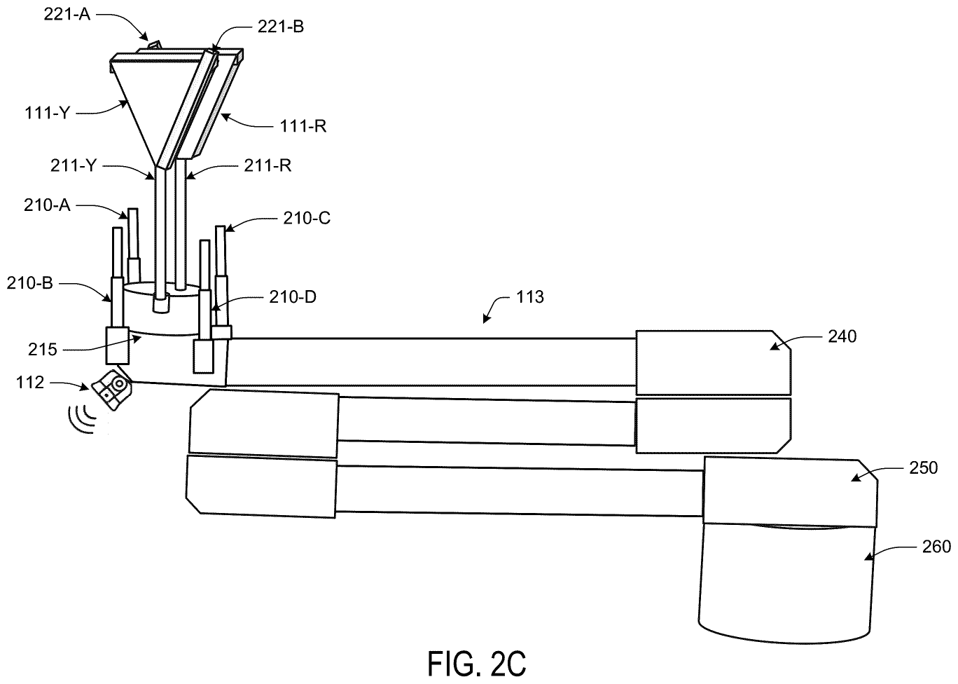

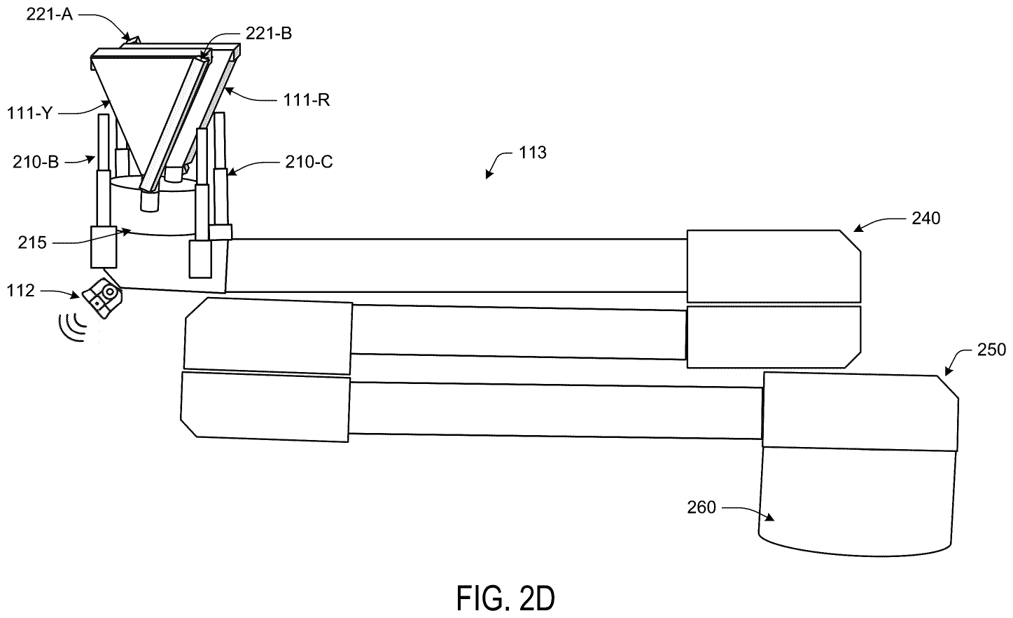

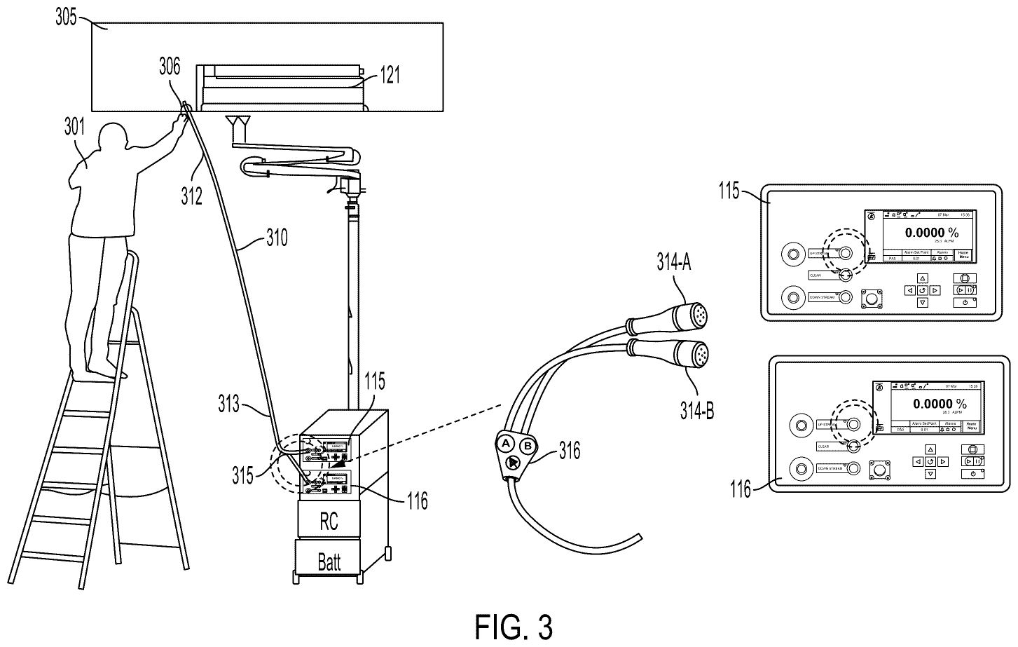

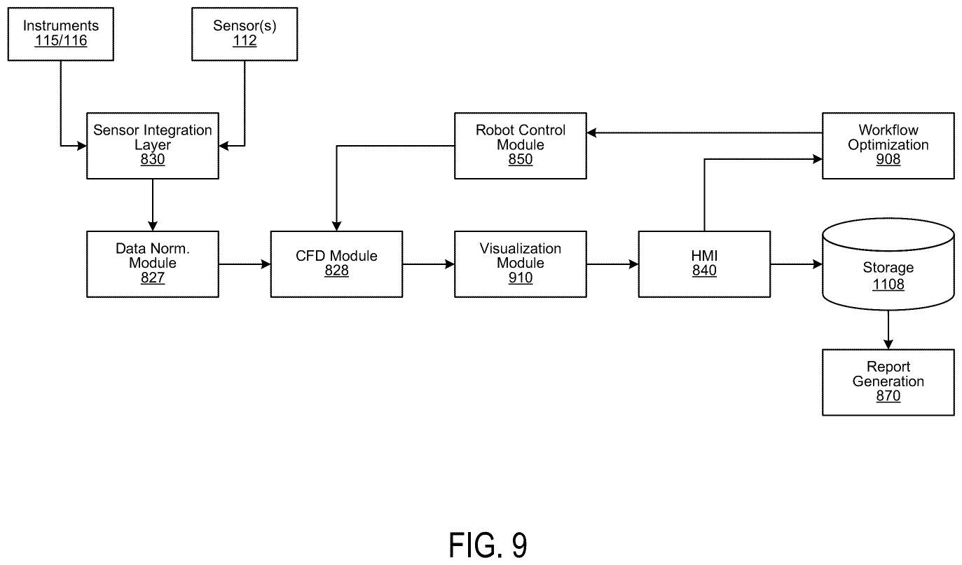

FIG. 1A illustrates the following components of the system 100:
111-Y—First of multiple isokinetic probes for HEPA filter scanning. (Note: Air sampling tube connections are shown in FIG. 3).
111-R—Second of multiple isokinetic probes for HEPA filter scanning. In some implementations, the first and second probes may rotate about an axis (indicated by the arrow 110) while maintaining the same distance between their inlet and the DUT. The system may maintain awareness of probe position to allow for pinpoint localization of leaks. The probes may be collectively referred to as “isokinetic probes 111.”
112—One or more sensors on a articulated arm 113 of the robotic device 105 for room measurement, positional sensing, proximity sensing, and/or obstacle avoidance. In various implementations, the sensor(s) may be used to, for example, identify the DUT, identify DUT boundaries (e.g., edges of a filter), generate a real-time map of the space (e.g., room), allow localization of the robotic device and/or the sensor(s), autonomously aid in navigation of the robotic device 105 through the space, detect HVAC ducts above ceiling tiles and/or behind walls (e.g., using a thermal camera and/or a thermal scan), etc. In some implementations, the data collected by the sensors may be used to create a computational fluid dynamic (CFD) model. Such a model may be used to, for example, optimize airflow in a room.
113—Articulated robot arm. The articulated arm 113 may have one, two, or more joints that allow segments of the arm to move at angles with respect to each other (e.g., by actuating a motor within the joint(s)). The articulated arm 113 may be configured to allow the system 100 to move probes/sensors positioned at the end of the arm (e.g., on a fixture 215 described below with reference to FIGS. 2A through 2D) along a planar path.
114—A pole or beam extending from a base of the robotic device. The telescoping pole 114 may extend or retract to modulate a vertical position of the arm. The telescoping pole 114 may mount to the cart 117 at various positions; for example, on a side of the cart as shown in FIG. 1A, the center of the cart as shown in FIG. 1B, or some other position.
115—First of several instruments (e.g., photometers and/or particle counters), connected wirelessly and/or via cable to a computer device.
116—Second of several instruments. Use of two (or more) photometers and/or particle counters (e.g., receiving samples from respective probes) may speed up DUT and/or cleanroom evaluation by increasing the surface area that the system can scan in a given period of time. Software may be used to ensure movement of the probe(s) complies with the relevant industry standard(s) (e.g., scanning rate and coverage of the test area) and to combine data from multiple instruments to produce a single test result.
117—Cart (e.g., a mobile base) for transporting test equipment. In some implementations, the robotic device 105 may move itself autonomously or semi-autonomously based on a contemporaneous analysis of the space to be evaluated.
118—Controller. The controller may include software and/or hardware configured to control various functions of the robotic device 105. For example, the controller 118 may include one or more microcontrollers, microprocessors, and/or memory for executing software that controls movement of the cart 117 and/or the articulated (e.g., multi-joint) arm 113. The controller may also control the test equipment and collect data. Processing and/or display of the data may occur in the robotic device and/or in a separate computer of the system.
119—Battery and/or other energy source to power the robotic device and test equipment.
120—Software executing on the robotic device 105 and/or a separate computer device 120 may be used to consolidate the temporal scanning results from the test equipment into a unified test result. In some implementations, the software may process data obtained from autonomous probe scans (e.g., when the controller 118 actuates the arm 113) and/or manual probe scans (e.g., when a user obtains the sample, such as when upstream readings are obtained prior to testing a filter). In some implementations, the operations of the controller 118 and the software may be performed using the same processor or processors. The controller 118 and/or the computer device 120 may include components as described below with reference to FIG. 9.
121—Filter (e.g., a ceiling-mounted HEPA filter).
122-A—Wheels to facilitate automatic and/or manual movement and positioning of the robotic device 105. In some implementations, the wheels 122-A may be mounted close to the cart 117 to create a smaller wheelbase that allows for more maneuverability in tight spaces. In some implementations, the wheels 122-A and/or casters 122-B may be mounted at the end of legs or outriggers as shown in FIG. 2B.

The system 100 may include one or more robotic device 105. A robotic device 105 may include a mobile base (e.g., the cart 117), a telescoping pole 114, and an articulated arm 113. The telescoping pole 114 may extend upwards (and/or outwards) from the cart 117. A first end of the telescoping pole 114 may be mechanically coupled to the cart 117. A second end of the telescoping pole 114 may extend away (e.g., upwards and/or outwards) from the cart 117. In some implementations, the telescoping pole 114 may include a motor and/or servo that allows for electrical control over extension and retraction (e.g., lengthening and shortening) of the telescoping pole 114. The send end of the telescoping pole 114 may be mechanically coupled to a first end of the articulated arm 113. A second end of the articulated arm 113 may extend away (e.g., outwards, upwards, and/or downwards) from the second end of the telescoping pole 114. The articulated arm 113 may include at least one joint between the first end and the second end. The articulated arm 113 may include two joints between the first end and the second end. The joint(s) may separate the articulated arm 113 into portions that may be moved at angles with respect to each other by actuating the joint (e.g., using one or more motors, servos, hydraulic pistons, etc.). In some implementations, the articulated arm 113 may be a selective compliance assembly robot arm (SCARA).

In some implementations, the robotic device 105 may have the cart 117, telescoping pole 114, articulated arm 113 configuration shown in FIG. 1A. In some implementations, the robotic device 105 may have different configurations. The particular configuration used may depend on a particular use case; for example, the configuration shown in FIG. 1A may be appropriate for a cleanroom environment generally consisting of smooth, level floors. In some cases, a robotic device 105 may be configured for more challenging environments that include sloped or uneven floors, steps, obstacles, debris, etc. In such cases, the robotic device 105 may have a humanoid configuration. For example, the mobile base (e.g., cart 117) of the robotic device 105 may be analogous to the hips, legs, and feet, and the joints of the articulated arm may be analogous to the shoulders, elbows, wrists. In such a configuration, the probe(s)/sensor(s) may be mounted to a fixture analogous to hands; although such a fixture may have more or fewer degrees of movement than a human wrist and/or hand. The instruments 115, 116 and/or other components of the robotic device 105 may be mounted in a thoracic and/or abdominal cavity of the robot, and/or mounted on or to the back or front.

The robotic device 105 may include one or more probes 111. The probe(s) 111 may be mechanically coupled to the second end of the articulated arm 113. The second end of the articulated arm 113 may include a rotating fixture (e.g., as shown in FIG. 2B and described below) that can turn/rotate the probes 111-R and 111-Y with respect to each other. In some implementations, the fixture may rotate the probes 111-R and 111-Y in more than one plane to, for example, scan at a constant distance from a surface of a DUT, when the surface is at an angle other than horizontal (e.g., vertical or slanted).

The first instrument 115 may receive air samples from the second isokinetic probe 111-R; for example, via a tube or hose. In some implementations, the tube or hose may be situated inside the articulated arm 113 as shown in FIG. 2B. The second instrument 116 may likewise receive air samples from the first isokinetic probe 111-Y. The instruments 115 and 116 may generate data representing particulate measurements taken using the samples obtained from the probes 111-R and 111-Y.

The system 100 may include one or more processors and one or more memory components configured to cause the one or more processors to perform certain operations. The processor(s) and/or memory component(s) are described in additional detail below with reference to FIG. 9. The processor(s) and/or memory component(s) may correspond to the controller 118 and/or the computer device 120. In some implementations, the system 100 may include only the controller 118 or only the computer device 120. In some implementations, the controller 118 and the computer device 120 may perform different functions; for example, the controller 118 may control movement of the cart 117 and/or actuation of the articulated arm 113, while the computer device 120 receives data from the instrument(s) and generates measurement profiles. In some implementations, operations may be otherwise divided, shared, and/or duplicated between the controller 118 and the computer device 120 without departing from the scope of the disclosure. In some implementations, both the controller and the computer device 120 may be a part of and/or mounted to the cart 117 (e.g., being part of the robotic device 105). In some implementations, the controller 118 may be mounted to and/or part of the robotic device 105 while the computer device 120 may be separate and/or distant from the robotic device 105. The controller 118 and/or the computer device 120 may communicate by various wired and/or wireless means as described herein.

Among other operations, the processor(s) may be configured to execute computer instructions (e.g., logic, firmware, and/or software) to perform various functions including the following. The processor(s) may control movement of the mobile base by, for example, actuating motors to rotate the wheels. The processor(s) may navigate the mobile base to positions with respect to a DUT and/or a location in a cleanroom environment where samples are to be obtained for measurement. The processor(s) may actuate the one or more joints of the articulated arm 113 to position the probes 111 and/or additional sensor(s) at a desired location for obtaining samples, the processor(s) may actuate the articulated arm 113 to scan the probes 111 and/or sensor(s) across a DUT. The processor(s) may receive measurement data from the instruments 115, 116 and generate a measurement profile of a DUT and/or a cleanroom.

As used herein, a DUT may refer to a filter 121, a workstation, biosafety cabinet, HVAC duct, and/or any feature of a cleanroom environment (e.g., walls, windows, doors, etc.), etc. The system 100 may detect leaks in and/or around any such DUTs. For example, in addition to detecting and characterizing leaks in a filter 121, the system 100 may detect leaks around the filter, in or around an HVAC duct (e.g., conveying fresh air to the cleanroom and/or return air from the cleanroom), in and/or around a biosafety cabinet and/or fume hood, in and/or around a workstation such as a laboratory bench or computer desk, in and/or around a window or door of a cleanroom, in a wall/floor/ceiling of the cleanroom, etc.,

FIG. 1B illustrates the cart 117 in additional detail, according to embodiments of the present disclosure. FIG. 1B illustrates the following components of the cart 117:
122-B—Casters to facilitate manual movement and positioning of the robotic device 105. The casters 122-B and wheels 122-A may be used interchangeably and/or in combination (e.g., two wheels 122-A and two casters 122-B).
123—A handle 123 to facilitate manual movement and positioning of the cart 117.
124—Buttons 124 and/or other controls for various functions of the robotic device 105 including, for example an emergency power off (EPO) button or switch.
125—A first bay 125 for receiving a first instrument 115.
126—A second bay 126 for receiving a second instrument 116.
127—One or more connectors for providing power to the first instrument 115 and/or transferring data between the first instrument 115 and the controller 118 and/or computer device 120.
128—One or more connectors 128 for providing power to the second instrument 116 and/or transferring data between the second instrument 116 and the controller 118 and/or computer device 120.

FIG. 2A illustrates an example articulated arm 113 with a sensor 112 and plurality of isokinetic probes. FIG. 2A illustrates the following components:
111-R—A first isokinetic probes for HEPA filter scanning.
111-Y—A second isokinetic probe for HEPA filter scanning.
112—One or more sensors on the arm of the robotic device. The one or more sensor(s) may be used to perform, for example, room measurement, positional sensing, proximity sensing, and/or obstacle avoidance. The sensor 112 may be used to navigate the robotic device 105 and/or the probes 111 to a desired location for obtaining an air sample or scanning a DUT.
113—An example multi-axis arm of the robotic device. Various implementations of the arm may be used including, for example, articulated, extending (e.g., telescoping), and/or rotating arms having various degrees/axes of movement.
114—A pole, beam, and/or other connection to a base of the robotic device. In some implementations, the pole may be extendible/retractable manually and/or via a motor or actuator to modulate a vertical position of the arm.
215—A fixture at the end of the articulated arm 113. The fixture 215 may serve as a mounting point for the various probes, sampling tubes, and/or sensors of the system 100. The fixture 215 may rotate with respect to the articulated arm 113 to move the probe(s)/sensor(s) with respect to each other while maintaining a fixed or approximately fixed distance from the filter 121 or other DUT. In some cases, the fixture 215 may rotate the probe(s)/sensor(s) about multiple axes as indicated by the arrows 110-A and 110-B. Although FIG. 2A shows two-axis rotation, in some implementations, the fixture 215 may rotate about three axes.

In some implementations, the robotic device 105 may include an additional sensor/sensors for reading identification data on a DUT. The identification data may be represented in, for example, an RFID tag, a barcode, a QR code, etc. The identification data may allow the system 100 to store and retrieve measurement data corresponding to the DUT. This may allow the system 100 to characterize the DUT over time (e.g., as part of a cradle-to-grave tracking system).

FIG. 2B shows another view of the example articulated arm 113 and isokinetic probes 111, according to embodiments of the present disclosure. FIG. 2B also shows an example array of sensors and/or sampling tubes 210-A, 210-B, 210-C, and 210-D (collectively “sensors 210”). In various implementations, the robotic device 105 may include more or fewer sensors 210. The sensors 210 may measure various characteristics of the environment including, but not limited to, airflow velocity, pressure and/or pressure differentials, humidity, temperature, VOC's, CO, CO₂, etc. In some cases, the fixture 215 and/or articulated arm 113 may include a valve or other actuator that can route a particulate sensor tube 210 to a particular sensor or instrument. For example, in some implementations, the system 100 may use one or more of the sensors 210-A through 210-D for airflow velocity measurement during a scan, and select a sensor 210 based on the scan direction at a particular time. If the scan direction changes and/or the fixture 215 is rotated, the system 100 may actuate the valve to direct samples from a different tube to the relevant sensor or instrument.

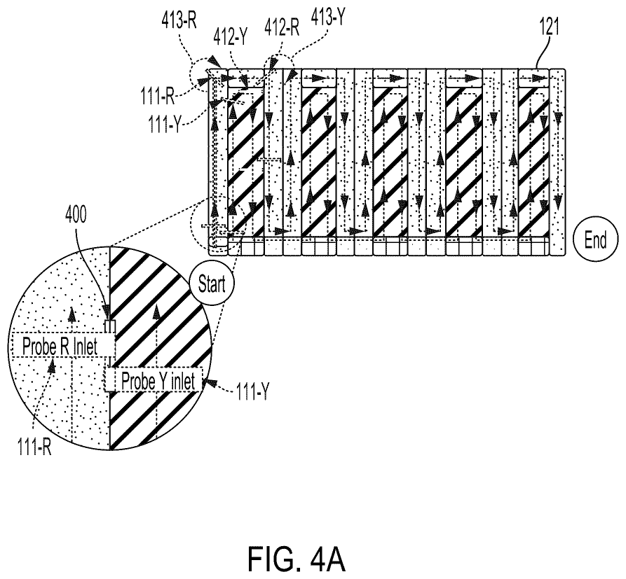

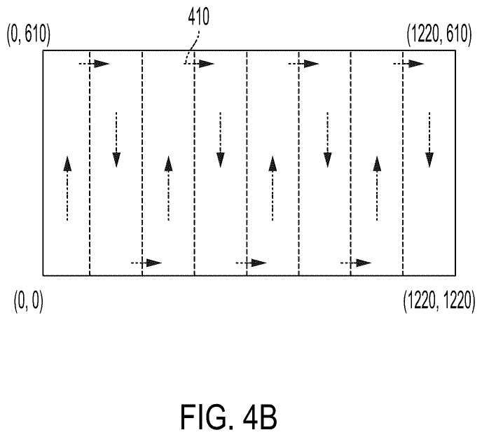

An end of the articulated arm 113 may have a rotating fixture 215 to which the probes 111 and/or sensors 210 may be attached. The robot system 100 may turn the rotating fixture 215 to achieve the desired scanning coverage of the combined probe and/or sensor area. An example scanning path and probe paths are shown in FIGS. 4A and 4B and described in further detail below.

FIG. 2B additionally illustrates a cross-sectional view 200 of the articulated arm 113 showing tubes/hoses connecting:
The second isokinetic probe 111-R and the first instrument 115 (“A”).
The first isokinetic probe 111-Y and the second instrument 116 (“B”).
An airflow velocity sensor tube 210-A and an airflow velocity-measuring instrument.
A pressure sensor tube 210-B and a barometer and/or other pressure-measuring instrument.

In various implementations, the articulated arm 113 may include more/fewer tubes/hoses. In some embodiments, an actuator or valve may connect a probe 210 to one of the tubes/hoses to facilitate measuring samples from a particular probe 210 to a particular sensor or instrument.

In some implementations, the system 100 may be configured to measure airflow velocity using the sensor tube 210-A to measure airflow velocity at a DUT during scanning of the DUT using the probes 111. The sensor tube 210-A may be arranged to minimize or eliminate any influence of the movement of the articulated arm 113 on the airflow velocity measurement (e.g., by positioning of the sensor tube 210-A perpendicular to the direction of scanning and/or using software correction). In various implementations, airflow velocity may be measured using a tube such as a Pitot tube, airfoil, and/or anemometer. By combining the airflow velocity and particulate measurements and performing them contemporaneously, the system 100 may reduce the time taken to characterize the DUT and generate a measurement profile.

In some implementations, the system 100 may use location data from the sensor 112 to determine a precise location and/or size of a leak. For example, the system 100 may correlate measurement data from the instruments 115, 116 with positional data from the sensor 112. In this manner, the system 100 may determine coordinates (e.g., Cartesian coordinates) corresponding to the location and extent of the leak in the DUT.

FIG. 2C shows a second example articulated arm 113 and isokinetic probes 111, according to embodiments of the present disclosure. A first end of the articulated arm 113 mounts to the telescoping pole 114. The mount 260 may mechanically couple the first end of the articulated arm 113 to the telescoping pole 114. The telescoping pole 114 may extend or retract to adjust the height of the articulated arm 113 and the probe(s)/sensor(s) mounted thereto to facilitate testing of a filter 121 or other DUT that is positioned in an elevated location, such as ceiling-mounted filters. The fixture 215 mounts to a second end of the articulated arm 113. The fixture 115 may have mounted to it one or more probes or sensors. The fixture 215 may rotate around one or more axes to position and/or scan the probe(s)/sensor(s).

The fixture 215 may serve as a mounting point for the isokinetic probes 111-Y and 111-R. In some implementations, the system 100 may include more or fewer isokinetic probes 111. The first isokinetic probe 111-Y may connect via hose or tube to the first instrument 115 while the second isokinetic probe 111-R may connect to the second instrument 116. The instrument 115 and/or 116 may be a particle counter or photometer. The system 100 may actuate the articulated arm 113 to scan the isokinetic probes 111 across a filter 121 and/or other DUT. The system 100 may control the scan to allow for simultaneous sampling from different (although potentially overlapping) regions of the filter 121 or DUT simultaneously to decrease measurement time while maintaining a scan speed (e.g., in cm/s) specified by the relevant testing standard and/or protocol.

In some implementations, the system 100 may include one or more aerosol sampling extension tubes 211-Y and 211-R (collectively “aerosol sampling extension tubes 211”). The aerosol sampling extension tubes 211 may be used to position the isokinetic probes 111 at a desired distance from the filter 121 under test (e.g., 3 cm from a surface of the filter 121, as per ISO 14644 standards). Relative positions of the various probe(s)/sensor(s) may be controlled automatically by the system 100 and/or manually by a user. For example, the aerosol sampling extension tubes 211 may be configured to allow an airflow velocity sensors 210-A and/or other sensors 210 to maintain a distance from the filter 121 or DUT (e.g., 15 cm to 20 cm). The can ensuring simultaneous compliance with both airflow and filter integrity sampling standards.

In some implementations, the system 100 may include one or more precision probe heads 221-A and 221-B (collectively “precision probe heads 221”) mounted to the fixture 215. The precision probe heads 221 may be configured for pinpoint air sampling. For example, a precision probe head may have a smaller, narrower opening relative to the isokinetic probes 111, which may have longer, wider openings configured to sample air from a wider area. For example, while an isokinetic probe 111 may have an opening with a cross section on the order of a centimeter wide and a few centimeters long, a precision probe head 221 may have an opening no larger than a few millimeters in either dimension. The system 100 may use the precision probe head 221 to pinpoint a leak. For example, a leak may be discovered using data corresponding to a sample or samples obtained by one of the isokinetic probes 111. The system 100 may use the precision probe heads 221 to sample from a smaller area in the vicinity of the leak to increase the precision of leak localization, including size and extent. The system 100 may use the data obtained using the precision probe heads 221 to increase the accuracy of the size and/or location of the leak as reported in the measurement profile (e.g., using Cartesian coordinates). In some implementations, the precision probe heads 221 may be connected (e.g., via hose, tube, or other conduit) to one or more of various instruments. For example, a multi-way valve between the precision probe heads 221 and a selection of instruments may be actuated automatically by the system 100 and/or manually by a user to route samples obtained using the precision probe heads 221 to different instruments. In some cases, the fixture 215 and/or articulated arm 113 may include a valve or other actuator that can route a particulate isokinetic probe 111 and/or precision probe head 221 to a particular sensor or instrument. For example, in some implementations, the system 100 may perform a first scan to test a DUT using the isokinetic probes 111. If the system 100 detects a leak in the DUT, the system 100 may actuate the valve so that samples may be obtained with a precision probe head 221 and routed to the desired instrument. The system 100 may then perform a second pass of the area using the precision probe head 221 to pinpoint the exact leak location. In some cases, a second pass scan may be used for other purposes, such as pinpointing a source of contamination. Thus, in various implementations, the valve may be able to route samples from an isokinetic probe 111, precision probe head 221, and/or sensor tube to one or more of a particle counter, photometer, E-Nose, VOC detector, CO detector, CO₂ detector, pressure sensor, temperature sensor, humidity sensor, etc.

The system 100 may include one or more environmental sensors 210 such as, for example, an airflow velocity sensor 210-A, a barometric pressure sensor 210-B, temperature sensor 210-C, humidity sensor 210-D, etc. In some implementations, the system 100 may have multiples of one or more of these sensors. In some implementations, the system 100 may have more, fewer, or different sensors. The airflow velocity sensor(s) 210-A may measure airflow velocity while the system 100 scans the fixture 215 across a filter 121 or other DUT. The airflow velocity sensor(s) 210-A may be positioned and/or otherwise configured to reduce turbulence induced by the scanning movement and thus provide smooth, accurate readings. In some embodiments, the system may switch between sampling airflow velocity and other environmental characteristics with a same sampling tube 210 using, for example, a multi-way valve connecting the sampling tube 210 to one of a selection of sensors and/or instruments. In various implementations, the multi-way valve may be actuated automatically by the system 100 and/or manually by a user.

In some implementations, the articulated arm 113 may include one or more sensor board mounts 240 and/or 250. The first sensor board mount 240 may be configured to receive a sensor and/or instrument and allow it to be mechanically coupled to a joint of the articulated arm 113 (as shown) and/or along the length of a segment of the articulated arm 113 (not shown). The second sensor mount 250 may be configured to receive a sensor and/or instrument to a location on or near the mount 260. The sensor board mount 240 and/or 250 may allow an instrument or sensor to be mounted a shorter distance to the relevant probe 111 and/or sampling tube 210, thus reducing transit time between the probe/tube and the corresponding instrument/sensor. A software engine of the system 100 may adjust for varying transit times due to differing positions of sensors/instruments by, for example, synchronizing timestamps of the respective data streams.

In some implementations, the system 100 may include one or more positional sensors 112 at the end of the articulated arm 113 (e.g., on, adjacent to, or near the fixture 215). The positional sensor(s) 112 may function using LiDAR, SONAR, GPS, machine vision, etc. to determine a position of the fixture 215 and, by extension, the probe(s)/sensor(s). The system 100 may use positional data obtained using the positional sensor(s) 112 to perform various functions involved in testing a cleanroom environment. For example, the system 100 may use the positional data to map the cleanroom environment, determine the location for obtaining air samples, locate DUTs, navigate to the desired location and/or indicate to a user when the robotic device 105 and/or sensor(s)/probe(s) are in position for obtaining an air sample, avoid obstacles, determine the location/size of leaks, determine the location/size of sources of contamination, etc.

FIG. 2D shows another view of the second example articulated arm 113 and isokinetic probes 111, according to embodiments of the present disclosure. The components of the system 100 shown in FIG. 2D are similar to those shown in FIG. 2C, but without the aerosol sampling extension tubes 211. This configuration of the system 100 may be used, for example, when a distance to the filter 121 or other DUT is constrained, when the system 100 is performing a filter integrity test, when a closer distance to the DUT is used for airflow velocity measurement, and/or for conducting scans closer to the DUT (e.g., to assess laminar flow).

FIG. 3 illustrates establishing an upstream particulate concentration for a plurality of instruments 115, 116, etc. Upstream concentrations may be obtained using one or more tubes 310. In some implementations, the tube 310 may be a “Y” tube; for example, with a first end 312 for receiving the upstream sample from within a duct 305 feeding the HEPA filter 121 and/or other DUT(s), and a second end 313 having a first connector 314-A for connecting to the first instrument 115 and a second connector 314-B for connecting to the second instrument 116, etc. (collectively “tube connectors 314”). In some cases, each instrument 115, 116 (e.g., photometer and/or particle counter) may take and measure an upstream sample. An instrument may exhibit a tolerance such that measurements of a same sample may vary from instrument to instrument (e.g., by 10% or more). Thus, an upstream measurement may be taken using each instrument to establish an internal reference for subsequent downstream measurements, thereby ensuring each instrument can make an accurate evaluation of upstream versus downstream particle concentrations. In some cases, one or more of the instruments 115, 116 may continue taking periodic measurements of upstream particulate concentrations while (and/or in between) taking measurements of downstream particulate concentrations.

The example processes illustrated here outline steps for establishing an upstream concentration using multiple instruments. In a first example process, the first connector 314-A connects to the first instrument 115, and the second connector 314-B connects to the second instrument 116. In some implementations, two tubes may be used (e.g., one for each instrument) with ends of the tubes distal from the instruments receiving samples from within the duct 305 upstream of the HEPA filter 121. A user 301 and/or the robotic device 105 may insert the tubes or tube connectors 314 into the HVAC air sampling port. In some cases, this may include using a Y-adapter 315 to obtain samples for both instruments at the same time using a single sampling port 306.

In a second example process, the instruments may establish upstream concentrations sequentially using a single tube connected to (or more) instruments via a Y-valve 316 that can direct the sample flow to a particular instrument. The second example process may include inserting the tube 310 into the HVAC air sampling port 306, installing a Y-valve 316 or Y-adapter 315 into the upstream port of the instruments 115, 116, etc., setting the sampling tube 310 to the first instrument 115 (which can be done manually or automatically), measuring the upstream concentration using the first instrument 115, setting the sampling tube to the second instrument 116 (e.g., using the Y-valve 316), and measuring the upstream concentration using the second instrument 116. After using the upstream measurement to establish an internal reference for the instruments 115, 116, etc., readings from the instruments may be cleared, and downstream testing may commence (e.g., with a filter scan). In some implementations, the processes may potentially be automated.

Following upstream measurements and downstream testing, the system may use the data obtained (e.g., the internal reference(s) and/or test measurement(s)) to generate a test report. The system may consolidate the data obtained from respective instruments, taking into account their respective internal references and/or area(s) scanned to ensure the test report reflects accurate and consistent measurements of the scanned area(s) that takes into account, for example, tolerances and/or different calibrations of the instruments. If a leak or leaks are detected, the system may use information about the instrument that detected the leak, the corresponding probe that obtained the sample, and/or positional information about the probe's scanning path to localize the leak(s). The system may assign a unique identifier to a leak. The unique identifier may be used to store and retrieve information about the leak (e.g., Cartesian coordinates corresponding to location/size of the leak, particulate measurements corresponding to the leak, etc.). The leak identifier may be associated with an identifier corresponding to the DUT, such that multiple leaks/repairs of a DUT can be retrieved according to the DUT identifier. The information may be used to track the leak and/or a repair of the leak over time to determine whether the DUT is or is not performing according to the relevant industry/customer standard(s). For example, a standard may dictate a maximum total area of repair and/or maximum total repair size as a percentage of the DUT size. For example, a standard may dictate that no more than 3% of a filter 121 may be repaired, or it must be discarded and replaced. By retrieving the DUT history, based on an identity of the DUT determined through a radio/optical tag and/or location, the system 100 may determine whether the DUT has had any previous repairs and, if so, whether an additional repair necessitated by a new leak would result in the total repair area exceeding the area prescribed by the relevant standard. In such cases, the system 100 may output an indication that the DUT should be replaced, and avoid a wasted repair and/or a potentially time-consuming review of DUT test/repair records.

FIG. 4A illustrates an example of using rectangular isokinetic probes 111-R and 111-Y in coordinated scan of the HEPA filter 121. FIG. 4A also highlights the coordinated, overlapping movement paths 412-R and 412-Y of the probes 111-R and 111-Y during the scanning process.

FIG. 4A shows an example of scanning two isokinetic probes 111-R and 111-Y in overlapping paths 411-R and 411-Y, according to industry standards. In the example shown, the probes 111-R and 111-Y are configured to scan the HEPA filter 121 in a direction dictated by the scanning path 410 (e.g., as indicated by the arrows in FIG. 4B). The system may calculate the scanning path based on various factors including filter characteristics, test parameters, relevant industry standards, and/or the probes/sensors or instruments/test equipment used. FIG. 4A illustrates one possible embodiment of the movement and rotation 413-R, 413-Y of the probes at different stages of the scanning process; however, other probe scanning paths may be used including, for example, concentric circles or rectangles, a circular or rectangular spiral, etc.

FIG. 4B illustrates an example scanning path 410, according to embodiments of the present disclosure. The scanning path 410 may indicate the path traversed by the end of the articulated arm 113 as it scans the HEPA filter 121 and/or other DUT. The end of the articulated arm 113 may include a rotating fixture 215 on which the probes 111 and/or sensors 210 are mounted. By traversing the scanning path 410 with the rotating fixture 215, and turning the rotating fixture 215 to control the probe paths 411-R and 411-Y, the system 100 can ensure full coverage of the HEPA filter 121 or other DUT, including an amount of overlap (e.g., as indicated by the box 400) for satisfying industry/customer standards. In addition, the system 100 can correlate probe and/or sensor readings with positions on the DUT. For example, the corners of the scanning path 410 shown in FIG. 4B extend from (0,0) to (1220,610). The system 100 may factor in a delay (e.g., from a few tenths of a second to a few seconds) corresponding to the transit time of a sample between a probe 111 and an instrument 115, 116. In some cases, the delay may include a measurement time (e.g., a latency between an instrument receiving a sample and generating data representing the measurement). When the controller 118 receives measurement data, it can correlate the measurement data with the position of the prove and/or sensor at a time prior. Thus, when the system 100 detects a leak, it can determine precise positioning information including Cartesian coordinates mapping the extent of the leak.

FIG. 5 illustrates an example workflow of the system 100 for an automated scanning protocol. FIG. 5 illustrates how the system 100 may manage various operations during DUT scans.

In the example operations illustrated in FIG. 5, a user 301 (e.g., a Certifier) can operate two robotic devices 105-A and 105-B to increase throughput of a room evaluation. In some implementations, the two robotic devices 105-A and 105-B may share a computer device 120; in other implementations, each robot device 105-A and 105-B may have its own computer device 120. The first robot device 105-A may include two instruments 115-A and 116-A, and the second robot device 105-B may include two instruments 115-B and 116-B. The user 301 may take manual measurements in addition to the automated measurements obtained by the two robotic devices 105-A and 105-B. The computer device(s) 120 may receive measurement data from the instruments via wired and/or wireless data connections (e.g., a USB cable, wireless ethernet, Bluetooth, near-field communication (NFC), etc.).

The system software may serve one or more of the following functions:
Manage multi-user workflow, ensuring seamless coordination (e.g., between members of a certification team).
Receive data entry from various sources including test equipment, the robotic device controller, and/or manual input (e.g., including manual measurements and/or historical testing data).
Process scanned image uploads.
Collect additional cleanroom certification test data.
Compile gathered data into a comprehensive report.
2. User Profiles: The system 100 may support role-based access, with distinct roles for Administrator, Supervisor, and/or Operator, etc.
3. Permissions: Each role may come with customizable access permissions, ensuring a user can only access functionalities for which permission has been granted.
4. Collaboration: To enable real-time data collection, the software may allow shared access (e.g., between team members, and/or customers, etc.).
5. Activity Logs: The system 100 may track and log user actions (e.g., for traceability, verification, invoicing, etc.).
6. Security: To protect sensitive data, multi-factor authentication and/or data encryption may be implemented to enhance data security.
7. Data Capture for Cleanroom Certification Tests: The system 100 may capture data across various tests including filter integrity tests, airflow velocity, room pressure differential, segregation, particle counts, smoke studies, relative humidity (RH) & temperature measurements, sound and vibration metrics, light intensity.

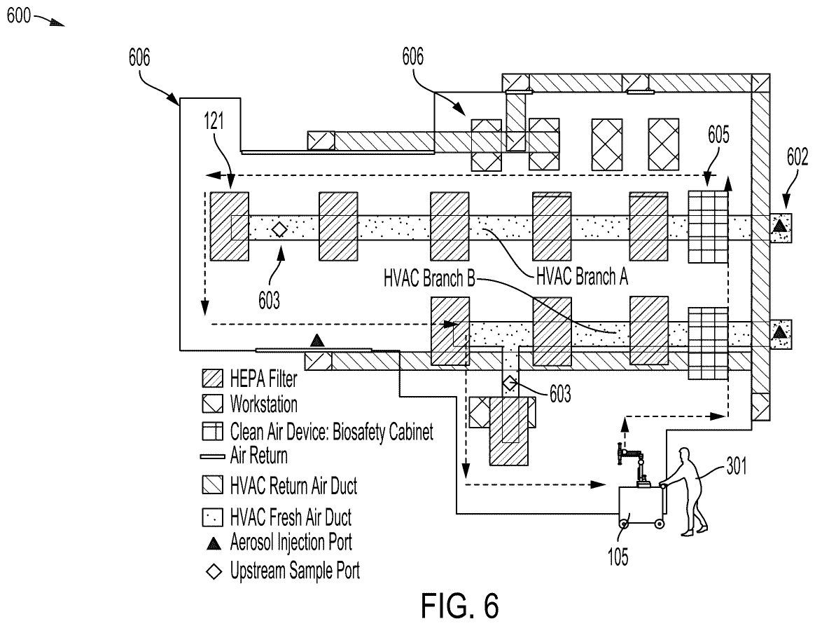

FIG. 6 illustrates an example of mapping a cleanroom environment 600 and performing workflow optimization, according to embodiments of the present disclosure.

The system 100 may create a map of the cleanroom environment 600, including a meshed map of the cleanroom, anteroom, buffer areas, filters 121 and/or other DUTs 605/606, and/or HVAC infrastructure (e.g., HVAC Branches A and B). The DUTs may include one or more clean air devices 605 (e.g., biosafety cabinets), workstations 606, and/or filters 121. The system 100 may generate Cartesian coordinates for locations for taking test samples based on the cleanroom size, test requirements, and location of identified filters 121 and/or other DUTs 605/606. The cleanroom environment 600 may include one or more aerosol injection ports 602 through which particulates may be introduced to the cleanroom environment to test the effectiveness of the filters 121 at removing the particulates from the air.

The system 100 may take upstream air samples from HVAC ports 603 as described previously with reference to FIG. 3. A sample location may be assigned a unique identifier (ID), enabling accurate and replicable testing. In some implementations, the system 100 may utilize machine learning to optimize the workflow within the cleanroom by, for example, minimizing the travel distance of the robotic device between DUTs 605/606 and/or enhancing overall efficiency.

The system 100 and its probes 111 and/or sensor(s) 210 may be configured to provide a range of supplementary functions used in cleanroom certification and optimization. In various implementations, these features may include one or more of the following:
Real-Time Mapping: Using remote sensing technology, the system 100 may be capable of scanning cleanrooms and adjoining spaces to generate a map of the space in real-time (e.g., during test data collection). Such a detailed layout may facilitate efficient navigation and obstacle identification/avoidance.
Thermal Scanning: The system 100 may conduct thermal scans to identify HVAC ducts (e.g., above ceiling panels and/or behind walls) and potential thermal leaks, which may be useful for maintaining the controlled conditions within the cleanroom. In some implementations, thermal scanning may be accomplished using a thermal camera.
Other Cleanroom Certification Tests: Equipped with real-time situational awareness, the system 100 may perform and record data for a range of cleanroom certification tests as stipulated by industry standards. These tests may include segregation, contamination control, air pressure differential, temperature/relative humidity, lighting, sound, vibration measurements, airflow velocity, among other tests. The system 100 may capture both temporal measurements and/or Cartesian coordinates of the test equipment and DUT(s), which may promote reproducibility of all tests.
Workflow Optimization: The system may leverage machine learning to optimize workflow based on, for example, cleanroom size, test requirements, location of identified DUTs, and/or identities of the user(s). This may reduce the travel distance of the robotic device, enhancing efficiency in and/or speeding up the cleanroom certification process.

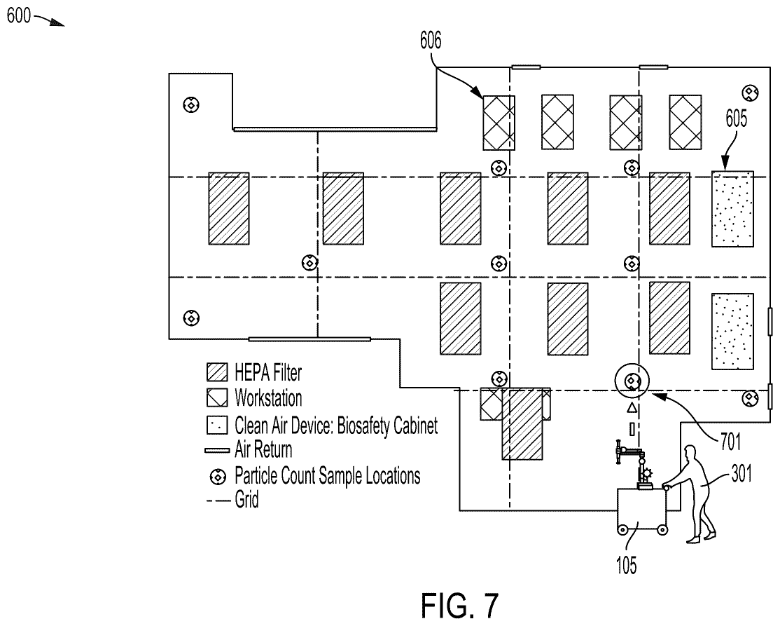

FIG. 7 illustrates an example collaborative robot (“cobot”) configuration of the robotic device 105, according to embodiments of the present disclosure. FIG. 7 illustrates example operations for validating particle count locations and performing workflow optimization.

The system 100 may create a map of a space such as a cleanroom environment 600 to determine the number of particle count test sample locations 701 to use based on room size, ISO class, and work surface areas. In some implementations, the system 100 may employ a machine learning model to identify testing locations, plan a path for the robotic device 105, and/or navigate to the designated sampling locations in the least amount of time and distance. In some implementations, the robotic device 105 may operate in a cobot manner in which a user 301 moves the robotic device manually and the robotic device 105 annunciates (e.g., by outputting a sound, light, vibration, etc.) when it and/or the probe(s) 111 and/or sensors 210 are in the proper position for sampling. The robotic device 105 may obtain a sample, measure it using an instrument 115, and record the data including, for example, particle count and location information. This process ensures accuracy and repeatability across successive cleanroom evaluations.

The robotic device 105, in this configuration, may showcase its capabilities to leverage Cartesian coordinates for precision and repeatability in its operations. In various implementations, this may entail:

Sample Location Planning: By referencing industry standards such as ISO 14644, the system 100 may determine the required number of particle count test sample locations based on room size and ISO class. An algorithm may generate Cartesian coordinates for test sample locations by taking into account room dimensions, contents of the room (e.g., furniture and/or fixtures), room occupancy, and/or work surface heights. Each sample location 701 may be assigned a unique ID, facilitating accurate and repeatable testing. In some implementations, the system 100 may utilize machine learning to optimize the workflow within the cleanroom by, for example, minimizing the travel distance of the robotic device between test locations 701 and/or DUTs 605/606 and/or enhancing overall efficiency.

Positioning of Sample Locations with Respect to DUTs: By capturing and utilizing Cartesian coordinates, the system 100 may ensure accurate positioning relative to any DUT, as required by industry standards. This precise positioning may be pivotal when performing filter integrity tests, as it guarantees that tests are conducted consistently and in compliance with industry standards.

Ingress/Egress/Pass-Through Tests: For tests like ingress, egress, and pass-through where positioning is crucial, the system's ability to determine, record, and/or reference Cartesian coordinates may be beneficial. The robot annunciates its positioning status, informing the operator when it is correctly aligned and ready to undertake the test. This annunciation ensures that the test equipment is in the right position relative to the DUT, eliminating human error and ensuring consistent results.

Repeatability: One of the paramount advantages of using Cartesian coordinates is the potential for repeatability. By storing these coordinates, the robot can revisit the exact positions during subsequent tests, ensuring consistent and repeatable results over time. This is especially beneficial for ongoing certifications and quality checks, where consistency across tests is a stringent requirement.

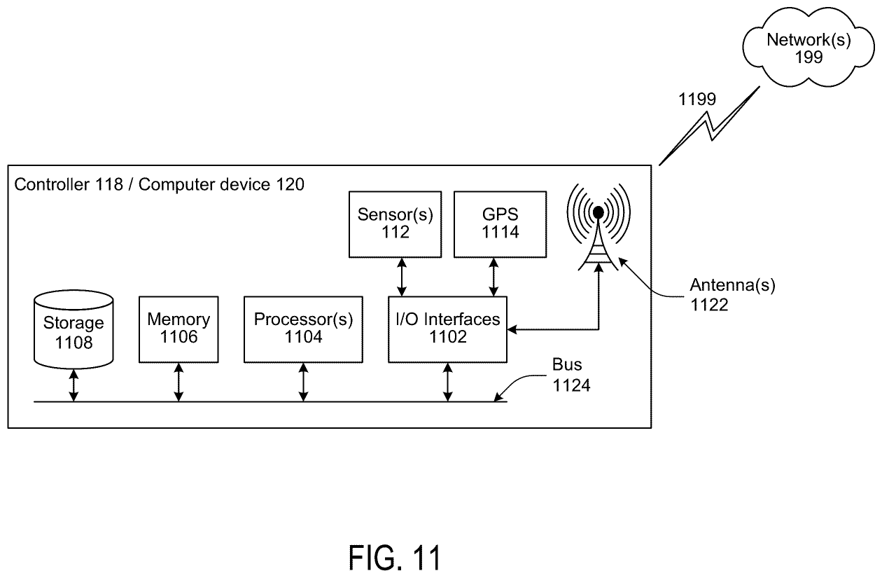

FIG. 8 is a block diagram illustrating data processing operations of the system 100, according to embodiments of the present disclosure. The system 100 may include one or more processors 1104, memory components 1106, data storage components 1108, and/or I/O interfaces 1102 as further described below with reference to FIG. 11. The processor(s) 1104, memory component(s) 1106, data storage component(s) 1108, and/or I/O interface(s) 1102 may reside on a single device or multiple devices (e.g., the controller 118 and/or the computer device 120). In some implementations, the system 100 may interface with cloud data storage 860. The cloud data storage 860 may augment the local storage on the data storage component(s) 1108. Additionally, the system 100 may retrieve, from the cloud data storage 860, ICDs, ISO standards, customer standards, and/or other reference data. The I/O interface(s) 1102 may allow the processor(s) 1104 to interact with external devices including sensors, instruments, dongles, GPS 1114, one or more antennas 1122, etc. In some implementations, the system 100 may have a network interface 802 similar to, but separate from the I/O interface(s) 1102. In some implementations, the I/O interface(s) 1102 may also perform the functions of the network interface 802 (e.g., communicating with other devices over one or more wired and/or wireless computer network(s) 199 as shown in FIG. 11).

The data storage component(s) 1108 may store instructions that, when executed by the one or more processors 1104, cause the processor(s) 1104 to perform various operations described herein. The data storage component(s) 1108 may also store test results and/or processed data (e.g., measurement profiles, airflow visualizations, airflow reports, and/or cleanroom maps, etc.). The processor(s) 1104 may execute the software engine (e.g., including the instructions stored on the data storage component(s) 1108, process test data (e.g., particulate measurements), integrate sensor data (e.g., position, airflow, etc.), control algorithms (e.g., for navigating the cart 117, scanning the arm 113, etc.), and other operations of the system.

The system 100 may reference one or more interface control documents (ICDs) 810. The ICDs 810 may contain data regarding probes, sensors, instruments, and/or other devices of the system 100. The data may allow the software engine to interact with these components by, for example, ensuring compatibility in the data sent and/or received therefrom. The data may be used to control, calibrate, and/or translate data to/from these components.

The AI module 875 may execute one or more machine learning models to enhance various operations of the system 100. The AI module 875 may include hardware and/or software configured to perform training and/or inference operations using one or more machine learning models such as neural networks, support vector machines, etc. In some implementations, the AI module 875 may perform training and/or inference using the processor(s) 1104. In some implementations, the AI module 875 may leverage other processors. The processors used for machine learning processing may include one or more general purpose microprocessors and/or processors designed and/or configured for machine learning processing; for example, a graphics processing unit (GPU), tensor processing unit (TPU), etc. The AI module 875 may implement a model that the system 100 may use to navigate a cleanroom based on a map imported into the system 100 and/or generated by the system 100 based on data collected from one or more positioning sensors, GPS module 1114, etc.

The system 100 may include a human-machine interface (HMI) 840. The HMI 840 may include software executing on the computer device 120 (e.g., a laptop, computer tablet, and/or mobile phone, etc.) to provide a user interface that may be used for monitoring, controlling, and/or displaying real-time data from the robotic device 105, including from the instruments 115, 116; sensors 112, etc. The HMI 840 may provide and/or integrate with an interface (e.g., a graphical user interface (GUI)) to display data including the visualization of airflow (e.g., without the use of smoke), receive user input, provide control over testing procedures, etc.

The system 100 may include a data normalization module 827. The data normalization module 827 may include hardware and/or software for synchronizing the software engine with various instruments 115, 166 and/or sensors 112. The data normalization module 827 may use one or more ICDs 810 to maintain compatibility with the instruments 115, 166 and/or sensors 112 (e.g., by translating data).

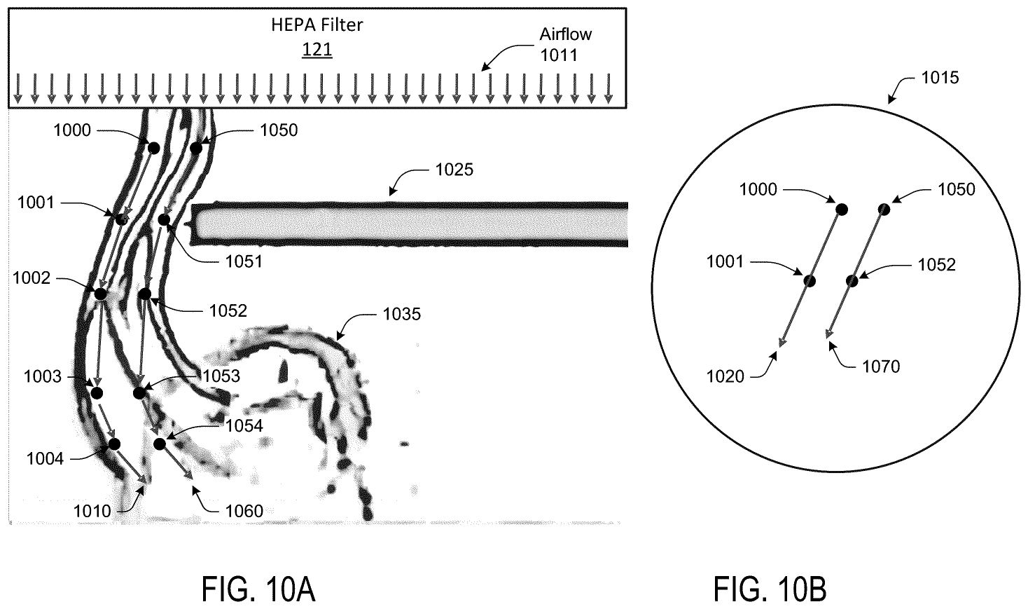

The system 100 may include a CFD module 828. The CFD module 828 may include software and/or hardware configured to process airflow data (e.g., collected by an airflow velocity sensor), data collected from other sensors (e.g., positioning sensors, object detection sensors, and/or information about a cleanroom layout. The CFD module 828 may process the airflow data and other data to simulate airflow and provide a visualization. An example visualization is shown in FIGS. 10A and 10B and described further below.

The system 100 may include a report generation module 870. The report generation module 870 may include software and/or hardware configured to receive test data from the data normalization module 827 as well as data regarding industry and/or customer standards for cleanroom certification, and generate certification reports. In some cases, the report generation module 870 may generate a report indicating why a particular DUT or cleanroom did not meet one or more requirements for certification. In any case, the report generation module 870 may include modifiable settings and/or configurations that allow customization of the format and/or appearance of reports.

The system 100 may include a data collection module 820. The data collection module 820 may include software and/or hardware configured to collect data from various devices (e.g., probes, instruments, and/or measurement sensors produced by different manufacturers). The data collection module 820 may retrieve ICDs 810 corresponding to the different probes/instruments/sensors, and provide the data and ICDs to the data normalization module 827.

The system 100 may include a robotic control module 850. The robotic control module 850 may include software and/or hardware configured to control the cart 117 (e.g., the mobile base of the robotic device 105) and the articulated arm 113. The robotic control module 850 may execute one or more algorithms to move the articulated arm 113 in a pattern that scans the probes 111 and/or sensors 112 at a specified rate and/or direction. The robotic control module 850 may execute one or more algorithms to navigate the robotic device 105 to a particular DUT and/or cleanroom environment location for air sampling. The robotic control module 850 may execute algorithms that allow the robotic device 105 to avoid obstacles while traversing a cleanroom environment. The robotic control module 850 may leverage data collected from the sensor(s) 112 as previously described. The robotic control module 850 may use the data collected from the sensor(s) 112 to create a map of the cleanroom environment including navigable paths, DUTs to characterize, and/or obstacles to avoid.

The system 100 may include a power management module 865. The power management module 865 may include software and/or hardware configured to charge and/or discharge the battery 119, monitor a charge status of the battery 119, monitor an operational status of the battery 119 (e.g., temperature, current, and/or voltage) and issue an alert of the battery 119 is operated in a manner potentially damaging to the system 100 and/or people nearby, and/or provide electrical power to various components of the system 100. For example, the power management module 865 may include one or more power converters, conditioners, filters, etc., that can provide power to the processor(s) 1104, memory 1106, sensor(s) 112, data collection module 820, HMI 840, etc.

The system 100 may include a sensor integration layer 830. The sensor integration layer 830 may include software and/or hardware configured to software and/or hardware configured to collect data from various sensors and send it to the data normalization module 827 for normalization (e.g., to a common scale) and/or translation (e.g., to a common unit).

FIG. 9 is a block diagram illustrating sensor measurement to airflow visualization operations of the system 100, according to embodiments of the present disclosure. The system 100 may receive data from the instruments 115, 116 and/or the sensors 112 at the sensor integration layer 830. The data collected may originate from one or more of the isokinetic probes 111-Y and 111-R, the airflow velocity sensor 210-A, barometric pressure sensor 210-B, temperature sensor 210-C, humidity sensor 210-D, etc. The sensor integration layer 830 may collect the data from the various probes, instruments, and/or sensors and send it to the data normalization module 827. The data normalization module 827 may translate the data to a common unit and/or normalize the data to a common scale. The data normalization module 827 may synchronize timestamps across data received from various sources (e.g., to a common clock and/or time zone). The data normalization module 827 may fuse the normalized and/or translated data from different sources for processing by the CFD module 828.

The data normalization module 827 integrates asynchronous data from multiple photometers and particle counters with varying flow rates and baseline measurements. The figure demonstrates the module's capabilities in temporal alignment, spatial mapping, and unit conversion, ensuring accurate and coherent data fusion for precise leak detection and airflow visualization.

The CFD module 828 may receive the data from the data normalization module 827 (and/or the data storage component(s) 1108) and perform CFD analysis. The CFD analysis may determine, for example, turbulence intensity, coefficient of variation, Reynolds number, etc., to provide quantifiable airflow insights. In some implementations, the CFD module 828 may receive feedback from, for example, the robotic control module 850. The CFD module 828 may send data representing the results of the CFD analysis to a visualization module 910.

The visualization module 910 may include software and/or hardware configured to depict the integration of normalized sensor data with CFD simulations to create visualization that highlight contaminant concentrations and/or airflow patterns. The visualization module 910 may receive outputs from the data normalization module 827 and the CFD module 828. The visualization module 910 may overlay the sensor data onto a CFD model to generate a detailed visualization. The visualization can illustrate areas with elevated VOC and/or particulate concentrations and show airflow paths that may disperse contaminants. This aids in objectively identifying contamination sources and ingress points for both mold, viral, VOC, and/or other contaminants. The visualization module 910 may process the normalized probe/sensor data and CFD results to generate 2D and/or 3D visualizations. The visualizations may represent, for example, simulations and/or reconstructions of measured aerosol properties and airflow patterns. The HMI 840 may use the visualization data from the visualization module 910 to display visualizations on a screen or monitor of the system 100 (e.g., on the computer device 120).

The system 100 may include one or more feedback loops that use CFD visualizations to update and optimize workflow for future scans. The system 100 may include a workflow optimization module 908 that includes hardware and/or software configured to track progress, in real-time of one or more technicians and/or one or more robotic devices 105 engaged in characterizing DUTs and/or performing cleanroom certification.

The data storage component(s) 1108 may receive data from the HMI 840 and/or other components/modules of the system 100 for storage. The data storage component(s) 1108 may store raw and/or processed data, including visualizations, securely for record keeping and/or further analysis, compliant with 21 C.F.R. Pt. 11 and ALCOA++ guidelines. The report generation module 870 may retrieve data for generating reports as previously described.

FIGS. 10A and 10B illustrate an example visualization of airflow and turbulence, according to embodiments of the present disclosure. FIG. 10A shows airflow 1011 through a HEPA filter 121 as indicated by the arrows. Using an airflow velocity sensor 210-A mechanically coupled to the of the articulated arm 113, the robotic device 105 may scan the vicinity of the HEPA filter 121 and map airflow velocity (e.g., speed and direction) at the various points indicated in FIG. 10A. The system 100 may map two paths 1010 and 1060 of airflow around, for example, an obstruction 1025. The obstruction 1025 in the path of the airflow may be caused by an obstacle or blockage; for example, an object placed in the airflow path that causes turbulence 1035.

The system 100 may, using the airflow velocity sensor 210-A, measure the airflow velocity at points 1000, 1001, 1002, 1003, 1004, etc. of the first path 1010, and at points 1050, 1051, 1052, 1053, 1054, etc. of the second path 1060.

The system 100 may use the data collected at the various points to recreate a visualization 1015 of the airflow as shown in FIG. 10B. The system 100 may use the measurements taken at the points 1001, 1002, etc. to reconstruct a representative airflow path 1020. Similarly, the system 100 may use the measurements taken at the points 1051, 1052, etc. to reconstruct a representative airflow path 1070. The system 100 may display the visualization 1015 using, for example, the HMI 840 and a monitor/display of the computing device 120.

The system 100 may use the data collected to characterize the airflow in one or more ways. A first technique may create a visualization of airflow as shown in FIGS. 10A and 10B by measuring airflow at different distances from the filter 121, vent, DUT, etc. One or more airflow velocity sensors may be used to take point readings by making static measurements and multiple points in a plane and/or scanning the probe/sensor/sample tube across multiple planes (e.g., slices). The system 100 may use the point air velocity readings (e.g., from the points 1000, 1001, 1002, 1003, 1004, 1050, 1051, 1052, 1053, 1054, etc.) to reconstruct airflow profiles in the region from which the measurements were obtained.

A first technique may characterize a Reynolds number at one or more points. The Reynolds number may represent a quantification of how laminar or turbulent a flow is, where a higher Reynolds number corresponds to more turbulence and a lower Reynolds number corresponds to more laminar flow. The Reynolds number may be calculated based on the speed, density, viscosity (e.g., dynamic and kinematic) of a fluid as well as the characteristic length of the system (e.g., a diameter of a tube). The system 100 may estimate or determine factors like density and/or viscosity using environmental measurements such as temperature, humidity, pressure and/or pressure differentials, etc. The resulting Reynolds number is a directionless quantity that may be used to determine whether air is flowing as desired (e.g., through a filter or vent) and/or whether there is a leak or obstruction disrupting airflow.

FIG. 11 is a block diagram conceptually illustrating example components of the controller 118 and/or computer device 120 of the system, according to embodiments of the present disclosure. The controller 118 and/or computer device 120 may include an antenna 1122 for communicating via one or more communications links 1199 over a computer network or multiple computer networks 199, including communication between the controller 118 and computer device 120 in embodiments in which the two are separate. The controller 118 and/or computer device 120 may include one or more controllers/processors 1104, which may each include a central processing unit (CPU) for processing data and computer-readable instructions, and a memory 1106 for storing data and instructions of the respective device. The memories 1106 may individually include volatile random-access memory (RAM), non-volatile read only memory (ROM), non-volatile magnetoresistive memory (MRAM), and/or other types of memory. The controller 118 and/or computer device 120 may include a data storage component 1108 for storing data and controller/processor-executable instructions. Each data storage component 1108 may individually include one or more non-volatile storage types such as magnetic storage, optical storage, solid-state storage, etc. The controller 118 and/or computer device 120 may also be connected to removable or external non-volatile memory and/or storage (such as a removable memory card, memory key drive, networked storage, etc.) through respective input/output device interfaces 1102.

Computer instructions for operating the controller 118 and/or computer device 120 and its various components may be executed by the processor(s) 1104, using the memory 1106 as temporary “working” storage at runtime. The controller 118 and/or computer device 120 may store computer instructions in a non-transitory manner in non-volatile memory 1106, data storage component 1108, and/or an external device(s). Alternatively, some or all of the executable instructions may be embedded in hardware or firmware on the respective controller 118 and/or computer device 120 in addition to or instead of software.

The controller 118 and/or computer device 120 may include input/output device interfaces 1102. A variety of components may be connected through the input/output device interfaces 1102, as will be discussed further below. Additionally, the controller 118 and/or computer device 120 may include an address/data bus 1124 for conveying data among components of the controller 118 and/or computer device 120. Each component within the controller 118 and/or computer device 120 may also be directly connected to other components in addition to (or instead of) being connected to other components across the data bus 1124.

The controller 118 and/or computer device 120 may include input/output device interfaces 1102 that connect to a variety of components such as the one or more sensors 112 described previously. The sensor(s) 112 may include various sensors as described herein including sensors for detecting and/or measuring, for example, airflow velocity, temperature, humidity, pressure and/or pressure differentials, acceleration (e.g., an accelerometer), vibration, LIDAR, etc. The input/output device interfaces 1102 may also connect to a global-positioning system (GPS) 1114 component for determining a location of the system 100. In some implementations, the input/output device interfaces 1102 may connect to a speaker and/or microphone (not shown).

The input/output device interfaces 1102 may also connect to one or more antennas 1122. The antenna(s) 1122 may facilitate communication between controller 118 and/or computer device 120. Additionally or alternatively, the antenna(s) 1122 may facilitate communication between controller 118 and/or computer device 120 and other systems/devices including, for example, a database storing historical data captured by the controller 118, computer device 120, and/or other measurement systems. Via antenna(s) 1122, the input/output device interfaces 1102 may connect to one or more networks 199 via communication links 1199 such as a wireless local area network (WLAN) (such as Wi-Fi) radio, Bluetooth, near-field communication (NFC), and/or wireless network radio, such as a radio capable of communication with a wireless communication network such as a Long Term Evolution (LTE) network, WiMAX network, 3G network, 4G network, 5G network, etc. A wired connection such as Ethernet or USB may also be supported. Through the network(s) 199, the system may be distributed across a networked environment. The I/O device interface 1102 may also include communication components that allow data to be exchanged between devices such as different physical servers in a collection of servers or other components.

It is to be appreciated that embodiments of the systems and methods discussed herein are not limited in application to the details of construction and the arrangement of components set forth in this description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

### First Example Embodiments

The following paragraphs (S1) through (S32) describe first examples of systems that may be implemented in accordance with the present disclosure.

(S1) An autonomous or semi-autonomous robotic system for in-situ testing of filters may include a plurality of isokinetic scanning probes; a mobile base allowing movement across different environments; software integration capable of capturing Cartesian coordinates to pinpoint leak locations; adaptability features to adjust to various filter sizes, placement, and boundaries; and a mechanism to test the robustness of the filter housing and the tightness of the seals post-installation.

(S2) A system may be configured as described in paragraph (S1) and may further include a Y-adapter on an aerosol sampling tube connected to the aerosol sampling port, enabling the certifier to switch (manually or automatically via software) which photometer is sampling the upstream concentration so each photometer can establish a 100% upstream concentration.

(S3) A system may be configured as described in paragraphs (S1) or (S2), wherein the system is capable of maneuvering and pivoting, using its a robot base that can modulate its vertical position to scan wall-mounted HEPA filters or filters inside separative devices.

(S4) A system may be configured as described in any of paragraphs (S1) through (S3), wherein the system uses thermal scanning to identify ducts and potential leaks in the cleanroom environment.

(S5) A system may be configured as described in any of paragraphs (S1) through (S4), wherein the system is capable of autonomously planning a navigation path in real-time for the robot, taking into account obstacles detected by the vision sensors.

(S6) A system may be configured as described in any of paragraphs (S1) through (S5), wherein the robot generates a real-time map of the cleanroom environment, including a meshed map of the cleanroom, anteroom, buffer areas, and HVAC infrastructure.

(S7) A system may be configured as described in any of paragraphs (S1) through (S6), wherein the robot identifies clean air devices within the cleanroom, associates them with the correct test script, and ensures the device under test is linked to the tester, test equipment, and the test result.

(S8) A system may be configured as described in any of paragraphs (S1) through (S7), wherein the robot verifies its and the test equipment's correct positioning relative to the clean air device under test, as per selected industry test standards or guidelines, and autonomously identifies the device under test, before performing the test.

(S9) A system may be configured as described in any of paragraphs (S1) through (S8), wherein the robot is guided by a unique ID and Cartesian coordinates, validating its correct positioning before taking the particle count test sample.

(S10) A system may be configured as described in any of paragraphs (S1) through (S9), wherein the system records Cartesian coordinates for test equipment and timestamps of test results, allowing for identification of the point of failure of the clean air device or replication of test results.

(S11) A system may be configured as described in any of paragraphs (S1) through (S10), wherein the system generates a certification report that includes the Cartesian coordinates of each test location.

(S12) A system may be configured as described in any of paragraphs (S1) through (S11), wherein the robot automates the particle count test process, and it ensures compliance with industry standards such as ISO 14644.

(S13) A system may be configured as described in any of paragraphs (S1) through (S12), wherein the robot leverages artificial intelligence (AI) to optimize workflow, considering factors such as cleanroom size, test requirements, location of identified Devices Under Test (DUTs), and assigned staff.

(S14) A system may be configured as described in any of paragraphs (S1) through (S13), wherein the robot captures precise Cartesian coordinates of itself, test equipment, and the DUT, ensuring accurate, repeatable testing in compliance with industry standards.

(S15) A system may be configured as described in paragraph (S14), wherein the robot leverages artificial intelligence (AI) to minimizes the robot's travel distance, enhancing efficiency in the cleanroom certification process.

(S16) A system may be configured as described in any of paragraphs (S14) or (S15) and may further include a memory configure for storing time-stamped test data along with Cartesian coordinates of the robot, test equipment, and clean air device.

(S17) A system may be configured as described in any of paragraphs (S14) through (S16) and may further include software for automatically identifying and points of ingress/egress and accessing stored performance specifications.

(S18) A system may be configured as described in any of paragraphs (S12) through (S17) and may further include software for generating a map of the cleanroom environment for safe navigation using localization, object detection, and collision avoidance systems.

(S19) A system may be configured as described in any of paragraphs (S1) through (S18), and may further include a cart for transporting the certifier's test equipment through the cleanroom. Depending on the implementation, the robot may be a collaborative robot (cobot) manually moved by an operator, or in future iterations, it could be an Autonomous Mobile Robot (AMR), including a humanoid, or a UAV (Unmanned Aerial Vehicle).

(S20) A system may be configured as described in any of paragraphs (S1) through (S19) and may further include a battery configured to power the robot and test equipment.

(S21) A system may be configured as described in any of paragraphs (S1) through (S20) and may further include one or more processors and a memory storing instructions that, when executed, cause the one or more processors to combine data from the separate testing devices and generate a uniform report output.

(S22) A system may be configured as described in any of paragraphs (S1) through (S21) and may further include one or more sensors capable of performing a variety of additional tasks, such as creating real-time maps of cleanrooms and adjoining spaces and identifying devices under test (DUT).

(S23) A system may be configured as described in paragraph (S22), wherein the instructions further cause the one or more processors to reference industry standards such as ISO 14644 and determine the number of Particle Count test samples required based on room size and ISO class.

(S24) A system may be configured as described in any of paragraphs (S1) through (S23) and may further include one or more sensors configured to perform thermal scanning to identify potential leaks and HVAC ducts in the cleanroom environment.

(S25) A system may be configured as described in any of paragraphs (S1) through (S24) and may further include one or more processors and a memory storing instructions that, when executed, cause the one or more processors to process the collected data to perform Computational Fluid Dynamics (CFD) analysis to optimize airflow.

(S26) A system may be configured as described in any of paragraphs (S1) through (S25), and may further include one or more processors and a memory storing instructions that, when executed, cause the one or more processors to record data for a range of cleanroom certification tests as stipulated by industry standards, including segregation, contamination control, air pressure differential, temperature/relative humidity, lighting, sound, and vibration measurements.

(S27) A system may be configured as described in paragraph (S26), wherein the instructions further cause the one or more processors to capture temporal measurements and Cartesian coordinates of the test equipment and the Device Under Test (DUT) to ensure the reproducibility of all tests.

(S28) A system may be configured as described in any of paragraphs (S1) through (S27), and may further include one or more processors and a memory storing instructions that, when executed, cause the one or more processors to detect and identify points of ingress/egress.

(S29) A system may be configured as described in any of paragraphs (S1) through (S28), and may further include one or more processors and a memory storing instructions that, when executed, cause the one or more processors to generate Cartesian coordinates for test sample locations, uniquely identifying each sample location, enabling consistent testing.

(S30) A system may be configured as described in any of paragraphs (S1) through (S29), and may further include one or more processors and a memory storing instructions that, when executed, cause the one or more processors to store time-stamped test data and coordinates of the robot, test equipment, and clean air device.

(S31) A system may be configured as described in any of paragraphs (S1) through (S30), and may further include one or more processors and a memory storing instructions that, when executed, cause the one or more processors to utilize a real-time map, localization, object detection, and collision avoidance systems to navigate the cleanroom environment safely.

(S32) A system may be configured as described in any of paragraphs (S1) through (S31), and may further include one or more processors and a memory storing instructions that, when executed, cause the one or more processors to determine compliance with industry standards and generates a certification report.

### Second Example Embodiments

The following paragraphs (A1) through (A37) describe second examples of systems that may be implemented in accordance with the present disclosure.

(A1) A system for in-situ testing of a filter, the system comprising: a mobile base; an articulated arm having a first end mechanically coupled to the mobile base, a second end, and at least a first joint between the first end and the second end; a first isokinetic probe mechanically coupled to the second end of the articulated arm; a first instrument mounted to the mobile base and configured to receive first samples from the first isokinetic probe and generate first data representing a first particulate measurement; a second isokinetic probe mechanically coupled to the second end of the articulated arm; a second instrument mounted to the mobile base and configured to receive second samples from the second isokinetic probe and generate second data representing a second particulate measurement; and one or more processors configured to: actuate the at least first joint to scan the first isokinetic probe and the second isokinetic probe along a predetermined path with respect to a device under test, and process the first data and the second data to generate a first measurement profile of the device under test.

(A2) A system may be configured as described in paragraph (S1), wherein the articulated arm is a Selective Compliance Assembly Robot Arm (SCARA) capable of rotating to position the probes and sensors for testing filters in various orientations, including filters that exhaust upward or downward, or filters mounted vertically on walls, and wherein the one or more processors are further configured to control rotation of the articulated arm to accommodate different filter configurations.

(A3) A system may be configured as described in paragraph (A1) or (A2), and may further include: airflow velocity sensors, pressure sensors, and additional particulate measurement sensors mechanically coupled to the articulated arm, wherein at least some of the sensors are integrated near the end-of-arm for real-time data acquisition, wherein the one or more processors are configured to operate the sensors in concurrent mode, functioning simultaneously with the isokinetic probes during scanning of the filter, thereby capturing multiple testing metrics during a single scan.

(A4) A system may be configured as described in paragraph (A3), wherein the one or more processors are configured to execute a Sensor Interchangeability and Data Normalization software engine, which synchronizes and normalizes data from multiple sensors and instruments, including variations in sensor placement (remote or near the end-of-arm), data acquisition methods, and instruments from different manufacturers with distinct interface control documents (ICDs), to provide accurate and reliable testing results.

(A5) A system may be configured as described in paragraph (A4), wherein the software engine consolidates data from multiple sensors, including reconciling variations in sensor location, timestamp, and distance to the device under test, to provide a unified test result and accurate two-dimensional or three-dimensional visualizations of airflow behaviors.

(A6) A system may be configured as described in any of paragraphs (A1) through (A5), and may further include: a first sensor configured to determine position data corresponding to the first isokinetic probe and the second isokinetic probe, wherein the one or more processors are further configured to: process at least the first data and the second data to identify a presence of a leak in the device under test, and process at least the first data, the second data, and the position data to determine a position of the leak with respect to the device under test.

(A7) A system may be configured as described in any of paragraphs (A1) through (A6), and may further include: a first sensor configured to read identification data from a device under test, wherein the one or more processors are further configured to: receive, from the first sensor, third data representing a first identifier corresponding to the device under test, and retrieve, using the first identifier, fourth data representing a location of a repair in the device under test, actuate the at least first joint to scan a portion of the device under test corresponding to the location to determine fifth data corresponding to the first isokinetic probe and sixth data corresponding to the second isokinetic probe, and generate a second measurement profile corresponding to the repair.

(A8) A system may be configured as described in paragraph (A7), wherein the first sensor is a radio-frequency identifier (RFID) tag reader, and the third data is encoded in an RFID tag of the device under test.

(A9) A system may be configured as described in any of paragraphs (A1) through (A8), and may further include: a Y-tube having a first end for obtaining samples upstream with respect to airflow through the device under test and a second end having a first opening coupled to the first instrument and a second opening coupled to the second instrument, wherein the one or more processors are further configured to: receive third data representing a first upstream particulate measurement from the first instrument, receive fourth data representing a second upstream particulate measurement from the second instrument, and generate the first measurement profile of the device under test additionally using the third data and the fourth data, the first measurement profile representing a reduction in particulate concentration by the device under test with respect to the first upstream particulate measurement and the second upstream particulate measurement.

(A10) A system may be configured as described in any of paragraphs (A1) through (A9), wherein the one or more processors are further configured to, prior to actuating the at least first joint, control movement of the mobile base to position the mobile base with respect to the device under test.

(A11) A system may be configured as described in any of paragraphs (A1) through (A10), wherein the one or more processors are further configured to: determine a location in a cleanroom environment for obtaining an air sample; control movement of the mobile base to position the mobile base with respect to the location; obtain, from the first instrument, third data representing a third particulate measurement; and process the third data to generate a second measurement profile corresponding to the location.

(A12) A system may be configured as described in paragraph (A11), wherein the one or more processors are further configured to, prior to obtaining the third data, actuate the at least first joint to position the first isokinetic probe at the location.

(A13) A system may be configured as described in any of paragraphs (A1) through (A10), wherein the one or more processors are further configured to: determine that at least a portion of one or more of the first data or the second data indicates a leak in the device under test; and include an indication of the leak in the first measurement profile.

(A14) A system may be configured as described in any of paragraphs (A1) through (A13), wherein the one or more processors are further configured to: receive third data representing a standard for determining a presence of a leak in a device under test based on particulate measurements, and determine that the first data or the second data indicates a leak in the device under test based on a comparison of the first data and the second data to the third data.

(A15) A system may be configured as described in any of paragraphs (A1) through (A14), and may further include: Airflow velocity sensors, pressure sensors, temperature sensors, and humidity sensors mechanically coupled to the articulated arm, including sensors integrated near the end-of-arm for real-time measurements, wherein the one or more processors are configured to: Operate multiple sensors concurrently by controlling the isokinetic probes and the additional sensors to perform simultaneous measurements during the scanning of the device under test; Synchronize asynchronous data by utilizing a Data Normalization Module to align data with different refresh rates, timestamps, sensor placements, and sampling intervals, correlating measurements to specific locations on the device under test; Adjust for sensor placement variations by implementing algorithms that compensate for data acquisition differences caused by sensor proximity (remote or near the end-of-arm) and the associated impact on data timing and synchronization; Facilitate advanced airflow analysis by collecting necessary data for computational fluid dynamics (CFD) processing to visualize airflow without smoke.

(A16) A system may be configured as described in paragraph (A15), wherein the one or more processors are configured to execute a software engine that: Integrates multiple sensors by interfacing with a plurality of sensors and instruments, including devices from different manufacturers with distinct interface control documents (ICDs) and varying physical placements on the robotic device; Normalizes and synchronizes data by aligning asynchronously collected data from sensors with varying refresh rates, sampling intervals, sensor placements, and transit delays, mapping measurements to specific sections of the device under test; Performs computational fluid dynamics (CFD) analysis using the normalized data to calculate airflow characteristics and generate visualizations of airflow patterns, enabling smokeless airflow visualization; Optimizes workflow by utilizing machine learning algorithms for predictive path planning and real-time adjustments to the robotic device's movement, enhancing efficiency and accuracy.

(A17) A system may be configured as described in paragraph (A16), wherein the one or more processors are further configured to: Perform data fusion by merging multiple datasets from different sensors, including those integrated near the end-of-arm and those located remotely, to provide comprehensive analysis and visualization; Calculate airflow characteristics such as turbulence intensity, coefficient of variation, and Reynolds number, to assess flow uniformity and detect turbulence and eddies; Support extensibility by enabling the addition of new tests, parameters, and integration of third-party test equipment interface control documents (ICDs) through an extensible software architecture that accommodates different sensor placements and configurations.

(A18) A system may be configured as described in paragraph (A17), and may further include: A visualization module that generates real-time 2D/3D visualizations of the device under test and the testing environment, including airflow patterns derived from CFD analysis, supporting formats such as JPG, PNG, and animations; Human-machine interface (HMI) integration that interfaces with human-machine interfaces to display real-time data, allow user interaction, and provide control over testing procedures, including the visualization of airflow without the use of smoke.

(A19) A system may be configured as described in paragraph (A18), wherein the one or more processors are configured to: adjust for sensor proximity effects by calculating and compensating for variations in sensor readings caused by the relative positions of the robotic arm's airfoil and the isokinetic probes during movement; implement dynamic correction algorithms to modify data readings in real-time based on CFD simulations and empirical data to ensure accurate measurements regardless of the arm's orientation.

(A20) A system may be configured as described in any of paragraphs (A1) through (A19), and may further include: a first sensor configured to measure airflow velocity, mechanically coupled to the second end of the articulated arm; and a third instrument configured to generate third data representing an airflow velocity measurement obtained using the first sensor, wherein the one or more processors are further configured to generate the first measurement profile of the device under test additionally using the third data.

(A21) A system may be configured as described in paragraph (A20), wherein the airflow velocity measurement is performed during scanning of the first sensor, the first isokinetic probe, and the second isokinetic probe along the predetermined path.

(A22) A system may be configured as described in any of paragraphs (A1) through (A21), and may further include: a first tube having a first end for obtaining samples upstream with respect to airflow through the device under test and a second end coupled to the first instrument, wherein the one or more processors are further configured to: receive, from the first instrument, third data representing a first upstream particulate measurement, and generate the first measurement profile additionally using the third data, the first measurement profile representing a reduction in particulate concentration by the device under test with respect to the first upstream particulate measurement.

(A23) A system may be configured as described in paragraph (A22), and may further include: a second tube for obtaining samples upstream with respect to airflow through the device under test and coupled to the second instrument, wherein the one or more processors are further configured to: receive, from the second instrument, fourth data representing a second upstream particulate measurement, and generate the first measurement profile additionally using the fourth data.

(A24) A system may be configured as described in any of paragraphs (A1) through (A23), and may further include: a tube having a first end for obtaining samples upstream with respect to airflow through the device under test and a second end having a first opening coupled to the first instrument and a second opening coupled to the second instrument, wherein the one or more processors are further configured to: receive, from the first instrument, third data representing a first upstream particulate measurement, receive, from the second instrument, fourth data representing a second upstream particulate measurement, and generate the first measurement profile of the device under test additionally using the third data and the fourth data.

(A25) A system may be configured as described in any of paragraphs (A1) through (A24), wherein the one or more processors are further configured to: determine that at least a portion of one or more of the first data or the second data indicates a leak in the device under test; and include an indication of the leak in the first measurement profile.

(A26) A system may be configured as described in any of paragraphs (A1) through (A25), wherein the one or more processors are further configured to: receive third data representing a standard for determining a presence of a leak in a device under test based on particulate measurements, and determine that the first data or the second data indicates a leak in the device under test based on a comparison of the first data and the second data to the third data.

(A27) A system may be configured as described in any of paragraphs (A1) through (A26), wherein the one or more processors are further configured to: store time-stamped data and corresponding Cartesian coordinates for repeatable tests, aiding ongoing certification and quality assurance.

(A28) A system may be configured as described in any of paragraphs (A1) through (A27), and may further include: sensors such as LiDAR, sonar, thermal sensors, GPS, Bluetooth, or Wi-Fi antennas to determine the position of the mobile base within a room, allowing the system to capture positional data in a Cartesian coordinate system.

(A29) A system may be configured as described in any of paragraphs (A1) through (A28), wherein the robotic device is configured to: create a map of the cleanroom environment, including meshed maps of the cleanroom, anteroom, buffer areas, filters, and HVAC infrastructure.

(A30) A system may be configured as described in any of paragraphs (A1) through (A29), wherein the one or more processors are configured to: leverage machine learning algorithms to optimize workflow within the cleanroom by minimizing the travel distance of the robotic device between test locations and devices under test.

(A31) A system may be configured as described in any of paragraphs (A1) through (A30), wherein the one or more processors are further configured to: Collect data from airflow velocity sensors, pressure sensors, temperature sensors, and humidity sensors during scanning operations at multiple distances from the filter face; Calculate airflow characteristics, including turbulence intensity, coefficient of variation, and Reynolds number, using the collected data to assess flow uniformity and detect turbulence; and Generate airflow visualizations by processing the data through computational fluid dynamics (CFD) algorithms to create two-dimensional or three-dimensional representations of airflow patterns without the use of smoke.

(A32) A system may be configured as described in paragraph (A31), wherein the airflow visualization provides: Identification of laminar flow regions, turbulent areas, currents, and eddies within the cleanroom environment; Enhanced resolution through multiple parallel passes of the articulated arm, obtaining discrete measurements for detailed analysis; and An alternative to traditional smoke visualization studies, providing a smokeless method for airflow assessment.

(A33) A system may be configured as described in paragraph (A31), wherein the one or more processors are further configured to: Use measured temperature and pressure to calculate air density; Determine Reynolds number based on air density and mean velocity to indicate turbulence levels and potential for eddies.

(A34) A system may be configured as described in paragraph (A31), and may further include A computational fluid dynamics (CFD) module within the software engine that processes normalized sensor data to model airflow behaviors and predict airflow patterns.

(A35) A system may be configured as described in any of paragraphs (A1) through (A34), wherein the one or more processors are further configured to: perform computational fluid dynamics (CFD) processing to generate a simulation of airflow and contaminant dispersion within the cleanroom environment based on data from an airflow velocity sensor, pressure sensor, and temperature sensor; generate a visualization of the simulation; and overlay normalized data from one or more of an E-Nose sensor, a carbon monoxide sensor, a carbon dioxide sensor, volatile organic compound sensor, or particulate counter onto the visualization to indicate contaminant concentrations and identify a potential ingress point of contamination.

(A36) A system may be configured as described in paragraph (A35), wherein the one or more processors are further configured to: identify the potential ingress point by identifying an area where elevated levels indicated by the one or more sensors or particulate counter coincide with an airflow patterns leading back to the potential ingress point.

(A37) A system may be configured as described in paragraph (A35), wherein the CFD module can account for environmental conditions including one or more of temperature or humidity to enhance the accuracy of the simulation.

### Third Example Embodiments

The following paragraphs (R1) through (R32) describe third examples of systems that may be implemented in accordance with the present disclosure.

(R1) A system for in-situ testing of a device under test, the system comprising: a mobile base; a telescoping pole extending upwards from the mobile base, the telescoping pole having a first end mechanically coupled to the mobile base and a second end distal from the mobile base; an articulated arm extending outward from the second end of the telescoping pole, the articulated arm having a first end mechanically coupled to the second end of the telescoping pole, a second end distal from the telescoping pole, and at least a first joint between the first end and the second end, the first joint dividing the articulated arm into at least a first portion and a second portion and allowing movement of the first portion at an angle with respect to the second portion; a first isokinetic probe mechanically coupled to the second end of the articulated arm; a first instrument mounted to the mobile base and configured to receive first samples from the first isokinetic probe and generate first data representing first particulate measurements; a second isokinetic probe mechanically coupled to the second end of the articulated arm; a second instrument mounted to the mobile base and configured to receive second samples from the second isokinetic probe and generate second data representing second particulate measurements; a Y-tube having a first end for obtaining third samples upstream with respect to airflow through the device under test and a second end having a first opening coupled to the first instrument and a second opening coupled to the second instrument; one or more processors; and one or more memory components containing instructions that, when executed by the one or more processors, cause the one or more processors to: receive, from the first instrument, third data representing a third particulate measurement of the third samples, receive, from the second instrument, fourth data representing a fourth particulate measurement of the third samples, actuate the at least first joint to scan the first isokinetic probe and the second isokinetic probe along a predetermined path with respect to the device under test, and process the first data, the second data, the third data, and the fourth data to generate a first measurement profile of the device under test.

(R2) A system may be configured as described in paragraph (R1), further comprising: a first sensor mechanically coupled to the second end of the articulated arm, the first sensor configured to measure airflow velocity; and a third instrument configured to generate fifth data representing an airflow velocity measurement performed during scanning of the first sensor along the predetermined path, wherein the instructions further cause the one or more processors to: receive the fifth data contemporaneously with the first data and the second data, and generate the first measurement profile of the device under test additionally using the fifth data.

(R3) A system may be configured as described in paragraphs (R1) or (R2), further comprising: a first probe configured for pinpoint air sampling; a first sensor configured to determine position data corresponding to the second end of the articulated arm, wherein the instructions further cause the one or more processors to: process at least the first data and the second data to identify a presence of a leak in the device under test, process first position data to determine a first location of the leak, actuate the at least first joint to scan the first probe along a path with respect to the leak, receive fifth data representing a fifth particulate measurement corresponding to fourth samples obtained using the first probe, and process the fifth data and second position data corresponding to the first probe to determine Cartesian coordinates corresponding to a second location of the leak in the device under test, the second location representing a refinement of the first location.

(R4) A system may be configured as described in any of paragraphs (R1) through (R3), further comprising: a first sensor configured to determine position data corresponding to the second end of the articulated arm, wherein the instructions further cause the one or more processors: to process the position data to determine a first location of the device under test, determining, based on at least the first location, an identifier corresponding to the device under test, retrieve, using the identifier, fifth data representing a first repair of a first leak previously repaired in the device under test, process at least the first data and the second data to identify a presence of a second leak in the device under test, determining that a combined area of the first repair and a second repair of the second leak would exceed a maximum repairable area corresponding to the device under test, and in response to determining that the combined area would exceed the maximum repairable area, outputting an indication to replace the device under test.

(R5) A system may be configured as described in any of paragraphs (R1) through (R4), further comprising: a first sensor mechanically coupled to the second end of the articulated arm, the first sensor configured to measure airflow velocity; and a third instrument configured to generate airflow data representing an airflow velocity measurement obtained using the first sensor, wherein the instructions further cause the one or more processors to: receive, from the third instrument, fifth data representing first airflow velocity measurements corresponding to scanning along the predetermined path, receive sixth data representing second airflow velocity measurements corresponding to scanning along a second path, the second path corresponding to a different distance from the device under test relative to the predetermined path, performing a computational fluid dynamics (CFD) analysis using the fifth data and the sixth data to determine an airflow characterization of a vicinity of the device under test.

(R6) A system for in-situ testing of a device under test, the system comprising: a mobile base; an articulated arm having a first end mechanically coupled to the mobile base, a second end and at least a first joint between the first end and the second end; a first isokinetic probe mechanically coupled to the second end of the articulated arm; a first instrument mounted to the mobile base and configured generate first data representing a first particulate measurement corresponding to a first sample obtained using the first isokinetic probe and; a second isokinetic probe mechanically coupled to the second end of the articulated arm; a second instrument mounted to the mobile base and configured generate second data representing a second particulate measurement corresponding to a second sample obtained using the second isokinetic probe and; one or more processors; and one or more memory components containing instructions that, when executed by the one or more processors, cause the one or more processors to: actuate the at least first joint to scan the first isokinetic probe and the second isokinetic probe along a predetermined path with respect to a device under test, and process the first data and the second data to generate a first measurement profile of the device under test.

(R7) A system may be configured as described in paragraph (R6), further comprising: a first sensor mechanically coupled to the second end of the articulated arm, the first sensor configured to measure airflow velocity; and a third instrument configured to generate third data representing an airflow velocity measurement obtained using the first sensor, wherein the instructions further cause the one or more processors to generate the first measurement profile of the device under test additionally using the third data.

(R8) A system may be configured as described in paragraph (R7), wherein the airflow velocity measurement is performed during scanning of the first sensor, the first isokinetic probe, and the second isokinetic probe along the predetermined path.

(R9) A system may be configured as described in paragraph (R7), further comprising: a second sensor mechanically coupled to the second end of the articulated arm, the second sensor configured to generate fourth data representing one or more of temperature, humidity, or pressure, wherein the instructions further cause the one or more processors to: process the first data, second data, third data, and fourth data to determine an airflow characterization of a vicinity of the device under test.

(R10) A system may be configured as described in paragraph (R9), wherein the instructions further cause the one or more processors to: generate, using the first data, second data, third data, and fourth data first data, second data, third data, and fourth data, a visualization of airflow in the vicinity of the device under test.

(R11) A system may be configured as described in any of paragraphs (R6) through (R10), further comprising: a first sensor configured to determine position data corresponding to the first isokinetic probe and the second isokinetic probe, wherein the instructions further cause the one or more processors to: process at least the first data and the second data to identify a presence of a leak in the device under test, and process at least the first data, the second data, and the position data to determine a position of the leak with respect to the device under test.

(R12) A system may be configured as described in any of paragraphs (R6) through (R11), further comprising: a first sensor configured to read identification data from a device under test, wherein the instructions further cause the one or more processors to: receive, from the first sensor, third data representing a first identifier corresponding to the device under test, and retrieve, using the first identifier, fourth data representing a location of a leak in the device under test, actuate the at least first joint to scan a portion of the device under test corresponding to the location to determine fifth data corresponding to the first isokinetic probe and sixth data corresponding to the second isokinetic probe, and generate a second measurement profile corresponding to the leak.

(R13) A system may be configured as described in any of paragraphs (R6) through (R12), further comprising: a first sensor configured to read identification data from a device under test, wherein the instructions further cause the one or more processors to: receive, from the first sensor, third data representing a first identifier corresponding to the device under test, and retrieve, using the first identifier, fourth data representing a location of a leak in the device under test, actuate the at least first joint to scan a portion of the device under test corresponding to the location to determine fifth data corresponding to the first isokinetic probe and sixth data corresponding to the second isokinetic probe, and generate a second measurement profile corresponding to the leak.

(R14) A system may be configured as described in any of paragraphs (R6) through (R13), wherein the instructions further cause the one or more processors to: determine a first data format corresponding to the first data; determine a second data format corresponding to the second data, wherein the second data format differs from the first data format in one or more of data rate, timing information, or units; and determine third data representing a transformation of the second data into the first data format, wherein generating the first measurement profile includes processing the first data and the third data.

(R15) A system may be configured as described in any of paragraphs (R6) through (R14), further comprising: a tube having a first end for obtaining samples upstream with respect to airflow through the device under test and a second end having a first opening coupled to the first instrument and a second opening coupled to the second instrument, wherein the instructions further cause the one or more processors to: receive, from the first instrument, third data representing a first upstream particulate measurement, receive, from the second instrument, fourth data representing a second upstream particulate measurement, and generate the first measurement profile of the device under test additionally using the third data and the fourth data.

(R16) A system may be configured as described in any of paragraphs (R6) through (R15), further comprising: one or more sensors configured to determine location data, wherein the instructions further cause the one or more processors to: determine at least a first location in a cleanroom environment for obtaining a third sample; receive, from the one or more sensors, the location data; determine, using the location data, a current location; determine that the current location corresponds to the first location; and in response to determining that the current location corresponds to the first location, output an indication that the system is in position to obtain the third sample.

(R17) A system may be configured as described in any of paragraphs (R6) through (R16), wherein the instructions further cause the one or more processors to: receive third data representing characteristics of a cleanroom environment; and determine, using the third data, the at least first location.

(R18) A system may be configured as described in any of paragraphs (R6) through (R17), wherein the instructions further cause the one or more processors to: determine that at least a portion of one or more of the first data or the second data indicates a leak in the device under test; and include an indication of the leak in the first measurement profile.

(R19) A system may be configured as described in any of paragraphs (R6) through (R18), further comprising: a first sensor configured to determine position data corresponding to the second end of the articulated arm, wherein the instructions further cause the one or more processors to: process the position data to determine a first location of the device under test, determining, based on at least the first location, an identifier corresponding to the device under test, retrieve, using the identifier, third data representing a second measurement profile previously generated for the device under test, and generating the first measurement profile additionally using at least a portion of the third data.

(R20) A system may be configured as described in any of paragraphs (R6) through (R19), wherein the instructions further cause the one or more processors to: receiving third data representing a standard for determining a presence of a leak in a device under test based on particulate measurements, and determining that the first data or the second data indicates a leak in the device under test based on a comparison of the first data and the second data to the third data.

(R21) A system may be configured as described in any of paragraphs (R6) through (R18), further comprising: a first sensor configured to read identification data from a device under test, wherein the instructions further cause the one or more processors to: receive, from the first sensor, third data representing a first identifier corresponding to the device under test, and retrieve, using the first identifier, fourth data representing a location of a leak in the device under test, actuate the at least first joint to scan a portion of the device under test corresponding to the location to determine fifth data corresponding to the first isokinetic probe and sixth data corresponding to the second isokinetic probe, and generate a second measurement profile corresponding to the leak.

(R22) A system may be configured as described in any of paragraphs (R6) through (R21), wherein the instructions further cause the one or more processors to, prior to actuating the at least first joint, control movement of the mobile base to position the mobile base with respect to the device under test.

(R23) A system may be configured as described in any of paragraphs (R6) through (R22), wherein the instructions further cause the one or more processors to: determine a location in a cleanroom environment for obtaining an air sample; control movement of the mobile base to position the mobile base with respect to the location; actuate the at least first joint to position the first isokinetic probe at the location; obtain, from the first instrument, third data representing a third particulate measurement; and process the third data to generate a second measurement profile corresponding to the location.

(R24) A system may be configured as described in any of paragraphs (R6) through (R23), further comprising: a first tube having a first end for obtaining samples upstream with respect to airflow through the device under test; a valve receiving a second end of the first tube and configured to allow samples to flow through one of a second tube coupled to the first instrument or a third tube coupled to the second instrument, wherein the instructions further cause the one or more processors to: actuate the valve to allow the first instrument to receive a third sample, receive, from the first instrument, third data representing a first upstream particulate measurement corresponding to the third sample, actuate the valve to allow the second instrument to receive a fourth sample, receive, from the second instrument, fourth data representing a second upstream particulate measurement corresponding to the fourth sample, and generate the first measurement profile of the device under test additionally using the third data and the fourth data.

### Fourth Example Embodiments

The following paragraphs (M1) through (M32) describe examples of methods that may be implemented in accordance with the present disclosure.

(M1) A method for in-situ testing of a device under test, using a robotic device comprising a mobile base; a telescoping pole extending upwards from the mobile base, the telescoping pole having a first end mechanically coupled to the mobile base and a second end distal from the mobile base; an articulated arm extending outward from the second end of the telescoping pole, the articulated arm having a first end mechanically coupled to the second end of the telescoping pole, a second end distal from the telescoping pole, and at least a first joint between the first end and the second end, the first joint dividing the articulated arm into at least a first portion and a second portion and allowing movement of the first portion at an angle with respect to the second portion; a first isokinetic probe mechanically coupled to the second end of the articulated arm; a first instrument mounted to the mobile base and configured to receive first samples from the first isokinetic probe and generate first data representing first particulate measurements; a second isokinetic probe mechanically coupled to the second end of the articulated arm; a second instrument mounted to the mobile base and configured to receive second samples from the second isokinetic probe and generate second data representing second particulate measurements; a Y-tube having a first end for obtaining third samples upstream with respect to airflow through the device under test and a second end having a first opening coupled to the first instrument and a second opening coupled to the second instrument; the method comprising: receiving, from the first instrument, third data representing a third particulate measurement of the third samples; receiving, from the second instrument, fourth data representing a fourth particulate measurement of the third samples; actuating the at least first joint to scan the first isokinetic probe and the second isokinetic probe along a predetermined path with respect to the device under test; and processing the first data, the second data, the third data, and the fourth data to generate a first measurement profile of the device under test.

(M2) A method may be configured as described in paragraph (M1), wherein the robotic device further comprises a first sensor mechanically coupled to the second end of the articulated arm, the first sensor configured to measure airflow velocity; and a third instrument configured to generate fifth data representing an airflow velocity measurement performed during scanning of the first sensor along the predetermined path, the method further comprising receiving the fifth data contemporaneously with the first data and the second data; and generating the first measurement profile of the device under test additionally using the fifth data.

(M3) A method may be configured as described in paragraphs (M1) or (M2), further comprising: a first probe configured for pinpoint air sampling; a first sensor configured to determine position data corresponding to the second end of the articulated arm, wherein the instructions further cause the one or more processors to: process at least the first data and the second data to identify a presence of a leak in the device under test, process first position data to determine a first location of the leak, actuate the at least first joint to scan the first probe along a path with respect to the leak, receive fifth data representing a fifth particulate measurement corresponding to fourth samples obtained using the first probe, and process the fifth data and second position data corresponding to the first probe to determine Cartesian coordinates corresponding to a second location of the leak in the device under test, the second location representing a refinement of the first location.

(M4) A method may be configured as described in any of paragraphs (M1) through (M3), wherein the robotic device further comprises: a first sensor configured to determine position data corresponding to the second end of the articulated arm, the method further comprising: processing the position data to determine a first location of the device under test; determining, based on at least the first location, an identifier corresponding to the device under test; retrieving, using the identifier, fifth data representing a first repair of a first leak previously repaired in the device under test; processing at least the first data and the second data to identify a presence of a second leak in the device under test; determining that a combined area of the first repair and a second repair of the second leak would exceed a maximum repairable area corresponding to the device under test; and in response to determining that the combined area would exceed the maximum repairable area, outputting an indication to replace the device under test.

(M5) A method may be configured as described in any of paragraphs (M1) through (M4), wherein the robotic device further comprises: a first sensor mechanically coupled to the second end of the articulated arm, the first sensor configured to measure airflow velocity; and a third instrument configured to generate airflow data representing an airflow velocity measurement obtained using the first sensor, wherein the instructions further cause the one or more processors to: receive, from the third instrument, fifth data representing first airflow velocity measurements corresponding to scanning along the predetermined path, receive sixth data representing second airflow velocity measurements corresponding to scanning along a second path, the second path corresponding to a different distance from the device under test relative to the predetermined path, performing a computational fluid dynamics (CFD) analysis using the fifth data and the sixth data to determine an airflow characterization of a vicinity of the device under test.

(M6) A method for in-situ testing of a device under test, using a robotic device comprising a mobile base; an articulated arm having a first end mechanically coupled to the mobile base, a second end and at least a first joint between the first end and the second end; a first isokinetic probe mechanically coupled to the second end of the articulated arm; a first instrument mounted to the mobile base and configured generate first data representing a first particulate measurement corresponding to a first sample obtained using the first isokinetic probe and; a second isokinetic probe mechanically coupled to the second end of the articulated arm; a second instrument mounted to the mobile base and configured generate second data representing a second particulate measurement corresponding to a second sample obtained using the second isokinetic probe and; one or more processors; and one or more memory components containing instructions that, when executed by the one or more processors, cause the one or more processors to: actuate the at least first joint to scan the first isokinetic probe and the second isokinetic probe along a predetermined path with respect to a device under test, and process the first data and the second data to generate a first measurement profile of the device under test.

(M7) A method may be configured as described in paragraph (M6), wherein the robotic device further comprises: a first sensor mechanically coupled to the second end of the articulated arm, the first sensor configured to measure airflow velocity; and a third instrument configured to generate third data representing an airflow velocity measurement obtained using the first sensor, the method further comprising: generate the first measurement profile of the device under test additionally using the third data.

(M8) A method may be configured as described in paragraph (M7), wherein the airflow velocity measurement is performed during scanning of the first sensor, the first isokinetic probe, and the second isokinetic probe along the predetermined path.

(M9) A method may be configured as described in paragraph (M7), wherein the robotic device further comprises: a second sensor mechanically coupled to the second end of the articulated arm, the second sensor configured to generate fourth data representing one or more of temperature, humidity, or pressure, the method further comprising: processing the first data, second data, third data, and fourth data to determine an airflow characterization of a vicinity of the device under test.

(M10) A method may be configured as described in paragraph (M9), the method further comprising generating, using the first data, second data, third data, and fourth data, a visualization of airflow in the vicinity of the device under test.

(M11) A method may be configured as described in any of paragraphs (M6) through (M10), wherein the robotic device further comprises: a first sensor configured to determine position data corresponding to the first isokinetic probe and the second isokinetic probe, the method further comprising: processing at least the first data and the second data to identify a presence of a leak in the device under test, and process at least the first data, the second data, and the position data to determine a position of the leak with respect to the device under test.

(M12) A method may be configured as described in any of paragraphs (M6) through (M11), wherein the robotic device further comprises: a first sensor configured to read identification data from a device under test, the method further comprising: receiving, from the first sensor, third data representing a first identifier corresponding to the device under test; and retrieving, using the first identifier, fourth data representing a location of a leak in the device under test; actuating the at least first joint to scan a portion of the device under test corresponding to the location to determine fifth data corresponding to the first isokinetic probe and sixth data corresponding to the second isokinetic probe; and generate a second measurement profile corresponding to the leak.

(M13) A method may be configured as described in any of paragraphs (M6) through (M12), wherein the robotic device further comprises: a first sensor configured to read identification data from a device under test, the method further comprising: receiving, from the first sensor, third data representing a first identifier corresponding to the device under test; and retrieving, using the first identifier, fourth data representing a location of a leak in the device under test; actuating the at least first joint to scan a portion of the device under test corresponding to the location to determine fifth data corresponding to the first isokinetic probe and sixth data corresponding to the second isokinetic probe; and generating a second measurement profile corresponding to the leak.

(M14) A method may be configured as described in any of paragraphs (M6) through (M13), the method further comprising: determining a first data format corresponding to the first data; determining a second data format corresponding to the second data, wherein the second data format differs from the first data format in one or more of data rate, timing information, or units; and determining third data representing a transformation of the second data into the first data format, wherein generating the first measurement profile includes processing the first data and the third data.

(M15) A method may be configured as described in any of paragraphs (M6) through (M14), wherein the robotic device further comprises: a tube having a first end for obtaining samples upstream with respect to airflow through the device under test and a second end having a first opening coupled to the first instrument and a second opening coupled to the second instrument, the method further comprising: receiving, from the first instrument, third data representing a first upstream particulate measurement; receiving, from the second instrument, fourth data representing a second upstream particulate measurement; and generating the first measurement profile of the device under test additionally using the third data and the fourth data.

(M16) A method may be configured as described in any of paragraphs (M6) through (M15), wherein the robotic device further comprises: one or more sensors configured to determine location data, the method further comprising: determining at least a first location in a cleanroom environment for obtaining a third sample; receiving, from the one or more sensors, the location data; determining, using the location data, a current location; determining that the current location corresponds to the first location; and in response to determining that the current location corresponds to the first location, outputting an indication that the system is in position to obtain the third sample.

(M17) A method may be configured as described in any of paragraphs (M6) through (M16), the method further comprising: receiving third data representing characteristics of a cleanroom environment; and determine, using the third data, the at least first location.

(M18) A method may be configured as described in any of paragraphs (M6) through (M17), the method further comprising: determining that at least a portion of one or more of the first data or the second data indicates a leak in the device under test; and including an indication of the leak in the first measurement profile.

(M19) A method may be configured as described in any of paragraphs (M6) through (M18), wherein the robotic device further comprises: a first sensor configured to determine position data corresponding to the second end of the articulated arm, the method further comprising: processing the position data to determine a first location of the device under test; determining, based on at least the first location, an identifier corresponding to the device under test; retrieving, using the identifier, third data representing a second measurement profile previously generated for the device under test; and generating the first measurement profile additionally using at least a portion of the third data.

(M20) A method may be configured as described in any of paragraphs (M6) through (M19), the method further comprising: receiving third data representing a standard for determining a presence of a leak in a device under test based on particulate measurements; and determining that the first data or the second data indicates a leak in the device under test based on a comparison of the first data and the second data to the third data.

(M21) A method may be configured as described in any of paragraphs (M6) through (M18), wherein the robotic device further comprises: a first sensor configured to read identification data from a device under test, the method further comprising: receiving, from the first sensor, third data representing a first identifier corresponding to the device under test; retrieving, using the first identifier, fourth data representing a location of a leak in the device under test; actuating the at least first joint to scan a portion of the device under test corresponding to the location to determine fifth data corresponding to the first isokinetic probe and sixth data corresponding to the second isokinetic probe; and generating a second measurement profile corresponding to the leak.

(M22) A method may be configured as described in any of paragraphs (M6) through (M21), the method further comprising: prior to actuating the at least first joint, controlling movement of the mobile base to position the mobile base with respect to the device under test.

(M23) A method may be configured as described in any of paragraphs (M6) through (M22), the method further comprising: determining a location in a cleanroom environment for obtaining an air sample; controlling movement of the mobile base to position the mobile base with respect to the location; actuating the at least first joint to position the first isokinetic probe at the location; obtaining, from the first instrument, third data representing a third particulate measurement; and processing the third data to generate a second measurement profile corresponding to the location.

(M24) A method may be configured as described in any of paragraphs (M6) through (M23), wherein the robotic device further comprises: a first tube having a first end for obtaining samples upstream with respect to airflow through the device under test; a valve receiving a second end of the first tube and configured to allow samples to flow through one of a second tube coupled to the first instrument or a third tube coupled to the second instrument, the method further comprising: actuating the valve to allow the first instrument to receive a third sample; receiving, from the first instrument, third data representing a first upstream particulate measurement corresponding to the third sample; actuating the valve to allow the second instrument to receive a fourth sample; receiving, from the second instrument, fourth data representing a second upstream particulate measurement corresponding to the fourth sample; and generating the first measurement profile of the device under test additionally using the third data and the fourth data.

What is claimed is:

1. A system for in-situ testing of a device under test, the system comprising:
a mobile base;
a telescoping pole extending upwards from the mobile base, the telescoping pole having a first end mechanically coupled to the mobile base and a second end distal from the mobile base;
an articulated arm extending outward from the second end of the telescoping pole, the articulated arm having a first end mechanically coupled to the second end of the telescoping pole, a second end distal from the telescoping pole, and at least a first joint between the first end and the second end, the first joint dividing the articulated arm into at least a first portion and a second portion and allowing movement of the first portion at an angle with respect to the second portion;
a first isokinetic probe mechanically coupled to the second end of the articulated arm;
a first instrument mounted to the mobile base and configured to receive first samples from the first isokinetic probe and generate first data representing first particulate measurements;
a second isokinetic probe mechanically coupled to the second end of the articulated arm;
a second instrument mounted to the mobile base and configured to receive second samples from the second isokinetic probe and generate second data representing second particulate measurements;
a Y-tube having a first end for obtaining third samples upstream with respect to airflow through the device under test and a second end having a first opening coupled to the first instrument and a second opening coupled to the second instrument;
one or more processors; and
one or more memory components containing instructions that, when executed by the one or more processors, cause the one or more processors to:
receive, from the first instrument, third data representing a third particulate measurement of the third samples,
receive, from the second instrument, fourth data representing a fourth particulate measurement of the third samples,
actuate the at least first joint to scan the first isokinetic probe and the second isokinetic probe along a predetermined path with respect to the device under test, and
process the first data, the second data, the third data, and the fourth data to generate a first measurement profile of the device under test.

2. The system of claim 1, further comprising:
a first sensor mechanically coupled to the second end of the articulated arm, the first sensor configured to measure airflow velocity; and
a third instrument configured to generate fifth data representing an airflow velocity measurement performed during scanning of the first sensor along the predetermined path, wherein the instructions further cause the one or more processors to:
receive the fifth data contemporaneously with the first data and the second data, and
generate the first measurement profile of the device under test additionally using the fifth data.

3. The system of claim 1, further comprising:
a first probe configured for pinpoint air sampling;
a first sensor configured to determine position data corresponding to the second end of the articulated arm, wherein the instructions further cause the one or more processors to:
process at least the first data and the second data to identify a presence of a leak in the device under test,
process first position data to determine a first location of the leak,
actuate the at least first joint to scan the first probe along a path with respect to the leak,
receive fifth data representing a fifth particulate measurement corresponding to fourth samples obtained using the first probe, and
process the fifth data and second position data corresponding to the first probe to determine Cartesian coordinates corresponding to a second location of the leak in the device under test, the second location representing a refinement of the first location.

4. The system of claim 1, further comprising:
a first sensor configured to determine position data corresponding to the second end of the articulated arm, wherein the instructions further cause the one or more processors to:
process the position data to determine a first location of the device under test,
determine, based on at least the first location, an identifier corresponding to the device under test,
retrieve, using the identifier, fifth data representing a first repair of a first leak previously repaired in the device under test,
process at least the first data and the second data to identify a presence of a second leak in the device under test,
determine that a combined area of the first repair and a second repair of the second leak would exceed a maximum repairable area corresponding to the device under test, and
in response to determining that the combined area would exceed the maximum repairable area, output an indication to replace the device under test.

5. The system of claim 1, further comprising:
a first sensor mechanically coupled to the second end of the articulated arm, the first sensor configured to measure airflow velocity; and
a third instrument configured to generate airflow data representing an airflow velocity measurement obtained using the first sensor, wherein the instructions further cause the one or more processors to:
receive, from the third instrument, fifth data representing first airflow velocity measurements corresponding to scanning along the predetermined path,
receive sixth data representing second airflow velocity measurements corresponding to scanning along a second path, the second path corresponding to a different distance from the device under test relative to the predetermined path,
performing a computational fluid dynamics (CFD) analysis using the fifth data and the sixth data to determine an airflow characterization of a vicinity of the device under test.

6. A system for in-situ testing of a device under test, the system comprising:
a mobile base;
an articulated arm having a first end mechanically coupled to the mobile base, a second end and at least a first joint between the first end and the second end;
a first isokinetic probe mechanically coupled to the second end of the articulated arm;
a first instrument mounted to the mobile base and configured generate first data representing a first particulate measurement corresponding to a first sample obtained using the first isokinetic probe and;
a second isokinetic probe mechanically coupled to the second end of the articulated arm;
a second instrument mounted to the mobile base and configured generate second data representing a second particulate measurement corresponding to a second sample obtained using the second isokinetic probe and;
one or more processors; and
one or more memory components containing instructions that, when executed by the one or more processors, cause the one or more processors to:
actuate the at least first joint to scan the first isokinetic probe and the second isokinetic probe along a predetermined path with respect to a device under test, and
process the first data and the second data to generate a first measurement profile of the device under test.

7. The system of claim 6, further comprising:
a first sensor mechanically coupled to the second end of the articulated arm, the first sensor configured to measure airflow velocity; and
a third instrument configured to generate third data representing an airflow velocity measurement obtained using the first sensor, wherein the instructions further cause the one or more processors to generate the first measurement profile of the device under test additionally using the third data.

8. The system of claim 7, wherein the airflow velocity measurement is performed during scanning of the first sensor, the first isokinetic probe, and the second isokinetic probe along the predetermined path.

9. The system of claim 7, further comprising:
a second sensor mechanically coupled to the second end of the articulated arm, the second sensor configured to generate fourth data representing one or more of temperature, humidity, or pressure, wherein the instructions further cause the one or more processors to:
process the first data, second data, third data, and fourth data to determine an airflow characterization of a vicinity of the device under test.

10. The system of claim 9, wherein the instructions further cause the one or more processors to:
generate, using the first data, second data, third data, and fourth data first data, a visualization of airflow in the vicinity of the device under test.

11. The system of claim 6, further comprising:
a first sensor configured to determine position data corresponding to the first isokinetic probe and the second isokinetic probe, wherein the instructions further cause the one or more processors to:
process at least the first data and the second data to identify a presence of a leak in the device under test, and
process at least the first data, the second data, and the position data to determine a position of the leak with respect to the device under test.

12. The system of claim 6, further comprising:
a first sensor configured to read identification data from a device under test, wherein the instructions further cause the one or more processors to:
receive, from the first sensor, third data representing a first identifier corresponding to the device under test,
retrieve, using the first identifier, fourth data representing a location of a leak in the device under test,
actuate the at least first joint to scan a portion of the device under test corresponding to the location to determine fifth data corresponding to the first isokinetic probe and sixth data corresponding to the second isokinetic probe, and
generate a second measurement profile corresponding to the leak.

13. The system of claim 6, further comprising:
a first tube having a first end for obtaining samples upstream with respect to airflow through the device under test;
a valve receiving a second end of the first tube and configured to allow samples to flow through one of a second tube coupled to the first instrument or a third tube coupled to the second instrument, wherein the instructions further cause the one or more processors to:
actuate the valve to allow the first instrument to receive a third sample,
receive, from the first instrument, third data representing a first upstream particulate measurement corresponding to the third sample,
actuate the valve to allow the second instrument to receive a fourth sample,
receive, from the second instrument, fourth data representing a second upstream particulate measurement corresponding to the fourth sample, and
generate the first measurement profile of the device under test additionally using the third data and the fourth data.

14. The system of claim 6, wherein the instructions further cause the one or more processors to:
determine a first data format corresponding to the first data;
determine a second data format corresponding to the second data, wherein the second data format differs from the first data format in one or more of data rate, timing information, or units; and
determine third data representing a transformation of the second data into the first data format, wherein generating the first measurement profile includes processing the first data and the third data.

15. The system of claim 6, further comprising:
a tube having a first end for obtaining samples upstream with respect to airflow through the device under test and a second end having a first opening coupled to the first instrument and a second opening coupled to the second instrument, wherein the instructions further cause the one or more processors to:
receive, from the first instrument, third data representing a first upstream particulate measurement,
receive, from the second instrument, fourth data representing a second upstream particulate measurement, and
generate the first measurement profile of the device under test additionally using the third data and the fourth data.

16. The system of claim 6, further comprising:
one or more sensors configured to determine location data, wherein the instructions further cause the one or more processors to:
determine at least a first location in a cleanroom environment for obtaining a third sample;
receive, from the one or more sensors, the location data;
determine, using the location data, a current location;
determine that the current location corresponds to the first location; and
in response to determining that the current location corresponds to the first location, output an indication that the system is in position to obtain the third sample.

17. The system of claim 16, wherein the instructions further cause the one or more processors to:
receive third data representing characteristics of a cleanroom environment; and
determine, using the third data, the at least first location.

18. The system of claim 6, wherein the instructions further cause the one or more processors to:
determine that at least a portion of one or more of the first data or the second data indicates a leak in the device under test; and
include an indication of the leak in the first measurement profile.

19. The system of claim 6, further comprising:
a first sensor configured to determine position data corresponding to the second end of the articulated arm, wherein the instructions further cause the one or more processors to:
process the position data to determine a first location of the device under test,
determine, based on at least the first location, an identifier corresponding to the device under test,
retrieve, using the identifier, third data representing a second measurement profile previously generated for the device under test, and
generate the first measurement profile additionally using at least a portion of the third data.

20. The system of claim 6, wherein the instructions further cause the one or more processors to:
receive third data representing a standard for determining a presence of a leak in a device under test based on particulate measurements, and
determine that the first data or the second data indicates a leak in the device under test based on a comparison of the first data and the second data to the third data.
